(19) United States
(12) Patent Application Publication
(10) Pub. No.: US 2007/0255707 A1
(43) Pub. Date: Nov. 1, 2007

(54) System and method to work with multiple pair-wise related entities

(75) Inventors: Yuval Arie Tresser, New York, NY (US); Ygael Aaron Tresser, New York, NY (US); Erik Cohen, Jerusalem (IL); Philippe Ankaoua, London (GB); Daniel Nahum Rockmore, Hanover, NH (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Data Relation Ltd, London (GB)

(21) Appl. No.: 11/790,489

(22) Filed: Apr. 25, 2007

Related U.S. Application Data
(60) Provisional application No. 60/795,004, filed on Apr. 25, 2006.

(51) Int. Cl. G06F 17/30

(52) U.S. Cl. 707/6

(57) ABSTRACT

The invention uses pair-wise relations such as dissimilarity, similarity or correlation to identify related items by translating the relations into a set of points in a geometric space, where each point in the set of points represents an item, and where the distance between any two points directly corresponds to the dissimilarity value of the two items represented by the two points. A family of graphs is computed from the Voronoï diagram for the set of points. This family of graphs may be used for a variety of applications, including recommendation systems. For some applications, clustering may be used to assist in visualizing and identifying relations among items. In the case of recommendation systems, graphs reflecting customer preferences are clustered to identify customers with similar tastes.

### CROSS-REFERENCES TO RELATED APPLICATIONS

This application claims priority under 35 U.S.C. § 119(e) from U.S. Provisional Patent Application Nos. 60/795,004, filed Apr. 25, 2006, the subject matter of which is herein incorporated by reference in full.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

1. Field of the Invention

The present invention relates to a system and method for identifying items based on similarities of customers, where similarities are determined using techniques of computational geometry combined with data analysis methods used in the social and human sciences since the 1960s. In some embodiments, the present invention describes a system for identifying items that should be of interest to a potential customer, based on a combination of known customer preferences and customer behavior when said potential customer is in the presence of items of a similar kind. In these embodiments, the invention groups customers with similar preferences to aid in the identification of said items.

2. Background Art

The embodiments of the present invention are an advance on the classical and very successful techniques of Multidimensional Scaling (MDS), and the related Similarity Structure Analysis (SSA), which have been used in many disciplines to attach a geometric interpretation to any matrix of relations and thereby permit easier interpretation of these complex relations. To simplify the following discussion we will not distinguish between MDS and SSA in most of what follows.

MDS is a set of related statistical techniques that uses data visualization for exploring similarities or dissimilarities in data. An MDS algorithm starts with a matrix of item-item dissimilarities (or item-item similarities, or even a combination of dissimilarities and similarities), then assigns a location to each item in a low-dimensional space, suitable for graphing or 3D visualization. MDS algorithms fall into a taxonomy, depending on the meaning of the input matrix:
Classical multidimensional scaling, also known as Torgerson Scaling or Torgerson-Gower scaling, takes an input matrix giving dissimilarities between pairs of items and outputs a coordinate matrix whose configuration minimizes a loss function called strain.
Metric multidimensional scaling is a superset of classical MDS that generalizes the optimization procedure to a variety of loss functions and input matrices of known distances with weights and so on. A useful loss function in this context is called stress which is often minimized using a procedure called Stress Majorization.
Generalized multidimensional scaling is a superset of metric MDS that allows for the target distances to be non-Euclidean. In particular, it is clear that the extension of the invention as we shall present it here to the use of non-Euclidean geometries in the representation space is readily accomplished by people trained in mathematics.
Non-metric multidimensional scaling, in contrast to metric MDS, both finds a non-parametric monotonic relationship between the dissimilarities in the item-item matrix and the Euclidean distance between items, and the location of each item in the low-dimensional space. The relationship is typically found using isotonic regression. The measure of the lack of isotony may vary from case to case and from author to author. We use the word “strain” to refer to any such measure. When the strain is zero, the embedding is isotonic (i.e., the more dissimilar are two items, the further apart are the points that represent them). Quasi-isotony refers to the situation in which the strain is small enough so that a higher dimensional representation is not deemed necessary.
   Applications of MDS include scientific visualization and data mining in fields such as cognitive science, information science, psychophysics, psychometrics, finance, circuit representation and other aspects of methods of graphical display, marketing and ecology. Specifically, MDS is a statistical technique used in marketing for taking several aspects of the perceptions of respondents and representing them on a visual grid, called perceptual maps. Potential customers are asked to compare pairs of products and make judgments about their similarity. Whereas other techniques (such as factor analysis, discriminant analysis, and conjoint analysis) obtain underlying dimensions from reactions to product attributes identified by the researcher, MDS obtains the underlying dimensions from respondents' judgments about the similarity of products, and the conclusion does not depend on researchers' judgments or a list of attributes to be shown to the respondents. Instead, the underlying dimensions come from respondents' judgments about pairs of products. Because of these advantages, MDS is one of the most common techniques used in perceptual mapping.

The typical steps in performing MDS analysis include:
Formulating the problem, such as determining the products to be compared
Obtaining Input Data by asking respondents a series of questions. In an approach referred to as the Perception Data Direct Approach, each of the respondents rates the similarity of the selected products, usually on a 7 point Likert scale from very similar to very dissimilar. The number of pair-wise comparisons is a function of the number of products and is calculated as Q=N·(N−1)/2 where Q is the number of comparisons and N is the number of products. In another approach called the Perception Data Derived Approach, products are decomposed into attributes that are rated on a semantic differential scale. Alternatively, in the Preference Data Approach, respondents are asked their preference, a non-symmetric input that will not be used in the present invention.
Running a MDS statistical analysis that is available on numerous commercially available statistical applications programs. Often there is a choice between Metric MDS (which deals with interval or ratio level data), and Nonmetric MDS (which deals with ordinal data). The user of SSA or MDS must decide on the number of dimensions to be created, taking into account that increasing the number of dimensions may produce a better statistical fit, but make the final results more difficult to interpret. While the present invention, following the influence of authors such as Roger Shepard, Joseph Kruskal, and Louis Guttman was conceived as an extension of Nonmetric MDS and SSA, it could be used, but with a-priori inferior performance, with Metric MDS (where one not only has metric relations, but also considers them more important than the ordinal relations).
Mapping the results, usually in two-dimensional space, where the proximity of any two products indicates the similarity or dissimilarity of those products, depending on the specific MDS approach.
Testing the results for reliability and validity, generally through computing an R-squared value to determine what proportion of variance of the scaled data can be accounted for by the MDS procedure, where a minimum R-squared between 0 and 1 (such as 0.7) is pre-specified. Other possible tests are Kruskal's Stress, split data tests, data stability tests (e.g., eliminating one product), and test-retest reliability.

One downside of the known data relation visualization techniques is that they are not in general isotonic in low, i.e., visualizable, dimensions. Also, the known methods often do not come with means to provide a useful comparison of two outputs as needed for many applications, including commercial recommendations and evaluations.

### SUMMARY OF THE INVENTION

In response to these and other needs, embodiments of the present invention use the output of known analysis to create a family of graphs each of which provides a visual and geometric representation of the original relationship matrix. Embodiments of the present invention begin with a Relationship Matrix of entities produced using known techniques, and from this input, known techniques (e.g., MDS) may be used to derive a geometric embedding with entities now represented by points in some n-dimensional space. The dimension n can be varied, but in particular, can be picked for instance to insure isotony, or to preserve easy visualization and minimize computational cost. Using the geometric embedding, embodiments of the present invention create and most importantly teach how to use for any n that is chosen, a n-dependent one-parameter family of graphs that can be constructed as described in this invention and that are associated to the Voronoï diagram for the n-dimensional embedding of points that represent the original entities. This family of graphs (for whichever dimension n is chosen) ranges from the completely disconnected graph (i.e., each entity corresponds to a single vertex with no edges between vertices) to the fully connected graph (again, each entity corresponds to a different vertex, but now each vertex is connected to all other vertices) with parameter t that ranges continuously across a set of values that can be chosen as the set [symbol] of all real numbers or can be chosen as a compact set that includes the unit interval [0,1]. Two points within the range of values are fixed, with a Gabriel graph for t=0 and a Delone graph for t=1 (both being classically known graphs). Thus, each graph (except for the extremes of totally disconnected and totally connected) in the one-parameter family is a reflection of the relationship matrix and this one-parameter family of graphs is a new mathematical idea as well as a new idea (i.e., invention) for visualization and exploitation of the classical SSA or MDS approach.

As described above, one of the failings of known data correlation visualization techniques is that the output (assuming isotony) is generally high-dimensional with low-dimensional realizations sometimes requiring a tremendous violation of isotonic constraints. To address this need, embodiments of the present invention enable low-dimensional representations, since any graph, as a combinatorial object or topological object, has a geometric realization that can embedded in either two or three dimensions (and always has a realization with no crossings on a compact surface, i.e., an object that can be embedded in the Euclidean three-dimensional space). In this way, the graphs obtained in embodiments of the present invention can be applied to, for example, any of the classical uses of known data correlation visualization techniques within psychometry, sociometry, and more generally any formerly known domain of application of SSA or MDS.

In another type of application, a user can utilize the embodiments of the present invention to simplify the information contained in matrices that describe various kinds of correlations between financial securities in a basket and thus use the embodiments of the present invention to simplify the computations for the pricing of various derivative securities that depend on several underlying securities and as a means of finding groups of equities or other entities relevant to understanding the stock market (such as indices or exchanges) that tend to move together or those whose movements tend to be de-correlated.

There are many known ways to compute a distance between two graphs and some embodiments of the present invention exploit this comparison between graphs for many applications. We notice that it is true that the outputs of two data relations may be compared on the level of MDS outputs by using for instance the Hausdorff distance, the earth-moving distance or any metric defined between sets of points, but this would be at the costs of losing the benefit of having one-parameter families and losing the ability to visualize when the number of items in the item database becomes large. Furthermore, using graphs keeps more topology in the spirit of SSA and MDS while distances between point configurations produced by SSA or MDS would be a rather brutal insertion of distances in situations in which what should count (according to the spirit of MDS) is an isotonic representation of the entities whose mutual relations are being studied

In one embodiment, the comparison may be used for music recommendations or for the recommendation of any other form of media such as video by using the same techniques as for music. Specifically, each customer is represented by a relationship matrix indicating mutual relations between pairs of pieces of music and also, if possible, how much some (if not all) of the music pieces are liked and/or disliked. This matrix can be obtained by some combination of direct questioning and observation of customer listening behavior (available from online monitoring) and any other form of data gathering. Following the graphical methodology of the present invention, the customer can be represented by the collective of the one-parameter family of graphs, or more economically by a well chosen member of said family or a few such members. What is of interest is how the customer space clusters. Embodiments of the present invention determine clusters by fixing (after optimizing by trials and error for instance) a value of the parameter. For instance with no intent of limitation, one can choose or start by choosing before further adjustments, the parameter value t=0 that corresponds to the Gabriel graph associated to the points produced by SSA or MDS in some dimension chosen according to some tradeoff between minimizing the strain and simplifying the computation and minimizing storage. Each customer is now (represented by) a Gabriel graph. One could also use several graphs because one can consider several groups of music genres instead of all the genres at once, or use different level of granularities in the description of the musical universe where one would consider recordings, music pieces, genres, production year, etc., but the extension to many graphs is trivial.

In the case of a single graph representation, the inter-customer distance can be computed by defining the distance between two customers (i and j) as the distance between their respective Gabriel graphs, say Dᵢⱼ(0). In the notation Dᵢⱼ(0), the 0 represents the fact that one is using Gabriel graphs (the graphs for parameter equal to zero) to represent the customers. This computation of inter-customer distance can be done for any value of t, resulting in a continuously parameterized family of distance matrices D(t), although often a single value of t (or single method to assign a value of t) will be used. Clusters in these spaces may then be identified by using for instance any of the standard clustering techniques applied to the associated matrix distances. Different values of t may reveal useful (as determined by the user) characterizations of the market that can be utilized for recommendations (and also possibly to promote sales or some other form of information or advertising). One simple way in which this could work is that having defined music appreciation “communities” (i.e., customers of similar—as measured by the distance between graphs—listening profiles), when a given customer indicates liking an item of music (that can be either discovered by the customer or proposed to that customer by the user or an agent or associate of said user; the customer can be chosen at random or chosen because the customer has tastes that fit well with the community that the customer belongs to when it comes to new music pieces or music pieces that have not yet been tried by the community), that music would then be recommended to his/her entire community or several communities to which the customer belongs. These communities could be constructed across all music, within genre, or any other sort of understood subcategory. In fact, as soon as distances can be computed between representations that are deemed to be accurately representative of the customers (e.g., the graphs for some chosen parameter value or values), one can proceed with any variation on “collaborative filtering,” a family of technologies based on the principle that people with similar profiles tend to like and dislike the same things.

The embodiments of this invention for music recommendation use the relation between items that consist in the mean time between the listening of complete or almost complete (for example, at least 90%) instances of said items. One also uses how much all, or at least some, of the music in some collection is liked or disliked. One then stores these relations considered as dissimilarity values of a set of customers for a set of items in a database, where for each pair of items the dissimilarity value indicates how much time is spent between the listening of two items. Some values may be unknown. By considering as items the qualities “HATE” and “LIKE,” one considers as further dissimilarities how much some pieces are liked or disliked (such knowledge may come from statements of the customers or from measuring how often the various music pieces are listened to by the customer). Then, for each of the customers, the set of known dissimilarity values is translated into a set of points in a geometric space, where each point in the set of points represents an item, and where the distance between any two points directly corresponds (respecting isotony as much as possible in the chosen embedding dimension for the points) to the dissimilarity value of the two items represented by the two points. Then, a Voronoï diagram is computed for the set of points and a one-parameter graph family is associated by the present invention to the Voronoï diagram. Then, a parameter value, say t₀, is chosen and a graph of the one-parameter graph family determined by the parameter value t₀ is identified and constructed. Customers are clustered using as a distance between two customers the distance between the two customers' graphs for the value t₀ of the parameter. A list of recommended items corresponds to items preferred by other customers in the customer's cluster/community (where, as was explained above, the pieces preferred by other customers may come to the customers' attention in many ways).

The invention further supports adaptation to any field where MDS and SSA are applied, whether such applications are currently known or determined in the future. Further uses of the recommendation system aspect of the invention include casting of roles in movies, plays, and television shows, matching job applicants to jobs, as well as any form of matchmaking, including the matrimonial pairing. In some such embodiments, rather than searching for similarity (as expressed in graphs close to each other), such embodiments search for compatibility. Thus, part of the selection of the underlying data would be based on which characteristic, such as parts of one's personality, that one seeks to match. More generally, the invention may be adapted to any form of relations data in prospective fields of application.

The invention further includes a computer-implemented method for visualization of relations among data items, comprising storing pair-wise relation values in a database, each of the pair-wise relation values representing a relation between two of the data items, such that the pair-wise relation values have a partial ordering; translating the data items to a set of points in a geometric space, each point corresponding to a data item, such that the partial ordering of the pair-wise relation values is preserved by a distance metric on the geometric space; computing a one-parameter family of graphs on the set of points, such that a graph is computed for a value of a parameter, the value of the parameter being chosen according to pre-defined performance criteria; displaying at least one member of the one-parameter family of graphs to a user, where the at least one member is chosen according to the performance criteria.

### BRIEF DESCRIPTION OF THE DRAWINGS

The accompanying drawings are included to provide further understanding of the invention and are incorporated in and constitute a part of this specification. The accompanying drawings illustrate exemplary embodiments of the invention and together with the description serve to explain the principles of the invention. In the figures:

FIG. 1 illustrates an overview of a client-server system including a recommendation system;

FIGS. 2A and 2B illustrate a method for clustering similar customers and producing recommended items lists;

FIGS. 3A, 3B and 3C illustrate examples of customer taste representations;

FIG. 4 illustrates an overview of a clustering component;

FIG. 5 illustrates a method for computing clusters of customers;

FIG. 6 illustrates an example Voronoï tessellation;

FIG. 7 illustrates an example graph with distance values shown;

FIG. 8 illustrates an example one-parameter family of graphs;

FIG. 9 illustrates a method of computing a one-parameter family of graphs;

FIG. 10 illustrates a method of computing a sphere around a tuple of points; and

FIG. 11 illustrates a method of computing the family of graphs interpolating the Gabriel and Delone graphs.

### DETAILED DESCRIPTION OF EMBODIMENTS OF THE INVENTION

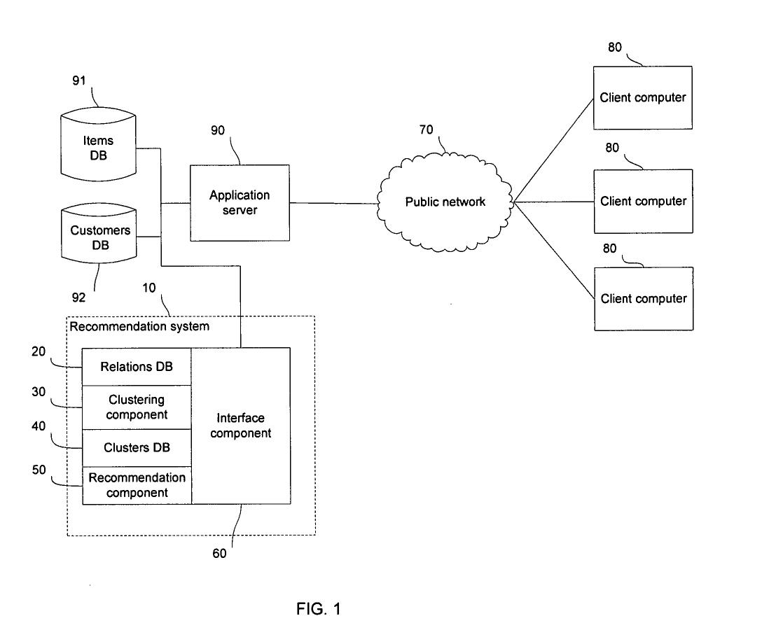

Illustrated in FIG. 1 is a client-server computer system with client computers 80 connected across a network 70 to an application server 90. The application server 90 is connected to an items database 91, a customers database 92, and a recommendation system 10. The client computers 80 may communicate with the application server 90 through a web page viewed in a web browser software, such as Microsoft Internet Explorer®, or through a standalone software client. The application server 90 provides access to items in the items database 91 through some application. For example, the application server 90 may host a website, such as a shopping website where a customer may purchase products listed in the items database 91. For a further example, the application server 90 may host a parts ordering application, where customers may requisition parts listed in the items database 91. The recommendation system 10 filters or ranks the items presented to the customer so that the customer is presented with recommended items, as discussed below. The recommendation system 10 further includes a relations database 20, a clustering component 30, a clusters database 40, a recommendation component 50, and an interface component 60. The relations database 20 stores the known (or approximately known) relation such as judgments of similarity or dissimilarity between some pairs of products of each customer for items in the items database 91.

If n is the number of items in the items database, for each customer an n×n matrix is stored, comparing the customer's relationship judgments on pairs of items. That is, the entry at row i and column j expresses the customer's preference for item i relative to item j, or may indicate that no data is available for that pair of items. In one embodiment, the preference is stored as an integer from 1 to 10. If no preference is known, some special value is used for that entry. Alternatively, one can use a zero, remembering where “lack-of-knowledge” zeros are put in the matrix to then be in position to use known techniques of compression of sparse matrices and some other manipulations of sparse matrices, as long as one can segregate out the effect of all manipulations on the “lack-of-knowledge” zeros. It should be understood that other types of values may be used. It should also be understood that a customer's pair-wise relations matrix might compare categories of items rather than individual items. In the case of music or videos, one could deal in a similar fashion with genres or authors, or instruments, or directors, or actors, etc., besides dealing with actual music or video pieces. One could also have a finer graining of the data and look at precise recordings for music and in the case of videos, differentiate between theater and TV edition or director's cut. Thus, if items were music albums, a pair-wise relations matrix might compare musical genres or musical artists, rather than comparing albums directly. One also could successively use matrices corresponding to different granularities, starting with the most coarse separation and moving to finer ones until arriving at the one that is of primary interest to serve the user of the invention or the needs of special customers of that user. The pair-wise relations database 20 is updated as new customers' opinions are learned. This updating may be performed in real-time, or may be done at regular intervals (these two methods being non-exclusive as the second could be more precise and could correct what is updated on the fly when needed). Management of pair-wise relations is discussed in more detail below for some preferred embodiments.

The clustering component 30 reads in data from the pair-wise relations database 20 and constructs clusters of customers. These clusters group customers by similarity of the representation of their tastes, represented according to this invention. The clustering algorithm is also discussed below. The cluster database 40 stores clusters that have been constructed. It should be understood that other methods of representation may be used concurrently as the goal is to get the best overall tool, and not to use the invention is such a way as to prevent using other methods. The recommendation component 50 delivers a list of recommended items for a customer. This recommended list is constructed using the cluster to which the customer belongs by identifying all items preferred by other customers in the cluster for which the customer has no known preference. In fact there may be several clusters for a customer, not only because of various granularities as discussed above, but also because some customers have varied interests and are more advantageously represented by collections of clusters, something that may be re-interpreted by saying that one takes account of the structure of the customer representation and can assign different weights to different pieces of the graph in one or more genres while the customer is listening or avoiding these genres. The interface component 60 contains programming logic used by the clustering component 30 and the recommendation component 50 to read data from the items database 91 and customer database 92, and to respond to requests from the application server 90. Also, once communities of customers begin to emerge, self-recommendation become possible by a customer exploring the graphs of customers with similar graphs, or with locally similar graphs. For example, if our tastes in classical music are the same, our respective relation to Hip Hop may be irrelevant in a first stage, and yet become a source of discovery for at least one of us.

In operation, the pair-wise similarities and dissimilarities for each customer are gathered and stored in the pair-wise relation database 20. Periodically, e.g., nightly, customers are clustered together by the clustering component 30, which reads in the (pair-wise) relation matrices from the pair-wise relation database 20. Clustering, of course, needs to be done online for new or non-recognized customers, or if a known customer explores genres or other collections of items that are not represented or are poorly represented in the dataset collected up to that moment for said customer. When the clustering component 30 finishes its computations, the computed clusters of customers are stored in the clusters database 40. The applications server 90 makes a request for recommendations for a customer to the interface component 60, which passes the request to the recommendations component 50. The recommendations component 50 looks up the cluster of the customer in the cluster database 40 and computes items preferred by customers in the cluster again, and in many places of the discussion, pieces of graphs can be considered rather than full graphs, and graphs for coarse splitting of the set of musical entities may be used to pre-select groups and/or individuals at lower cost before one uses more precise data descriptions. The recommendations component uses the pair-wise relations database 20 to determine for which items the customer has no expressed or otherwise recognized opinion, and filters those items from its list. The remaining list is ranked based on preference of customers in the cluster, and attributed proximities to other items by averaging such data over customers for whom said data can be read from their pair-wise relations matrices, and the ranked list is sent to the application server 90.

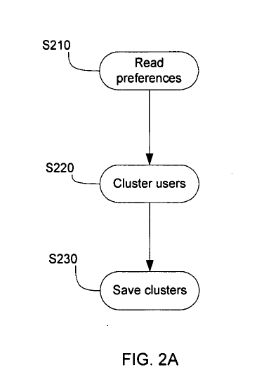

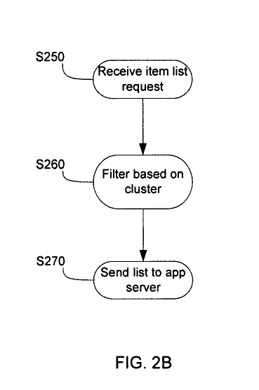

FIG. 2A illustrates a method of clustering customers. In step S210, customer pair-wise relation tables are read from the relations database. Step S220 uses these customer relations tables to identify clusters of customers, as explained in more detail below. In step S230, these customer clusters are saved to the customer database.

FIG. 2B illustrates a method for providing a list of recommended items. In step S250, the recommendation component receives a request for a list of recommended items from the application server. This request specifies the customer making the request or the customer recognized by the system as most probably ready to get recommendations. In step S260, the items in the items database are filtered for recommended items. First, the customer's cluster is read from the cluster database. Then, items preferred by other customers in the same (local or global) cluster are identified. Of those items, those for which the requesting customer has no known judgment are placed on the recommended items list, or pushed toward the customer. Notice that because of the nature of the data gathered and the way that data are stored and exploited, one can also by comparison make an educated guess of when should be good and bad times to recommend a given piece of music, an author, a special recording, etc. This constitutes one more advantage of the invention, but one that is restricted to music or video recommendation. It should be understood that the invention could also be used for other forms of recommendation such as: groceries where one basic measure of similarity between two products is the frequency with which they are bought together; books where a measure of dissimilarity is the time between the ordering of the two books, normalized by the average of this time over all the people who buy both books; and web-pages, where the measure of similarity between two pages is the inverse of the number of adding one to the sum of the number of mutual references of these pages and the number of times they are referenced by a same other page (these two numbers being possibly affected by some non-negative weights). For web-pages, a collection of “GOOD HUB” and “GOOD AUTHORITY” values would play the same type of role that “LIKE” and “HATE” plays for music, video, and groceries recommendations.

This process is related to collaborative filtering, which can be accomplished using standard techniques known in the art. We notice however that the method used here to compare customers is not only more subtle than just a list of preferences (hidden here in the relations of all or some items to “HATE” and “LIKE”), but also the very nature of how clustering is performed, helps determine when different recommendations should be made. Other representations of people by entities that have more than one dimension have been proposed, but ours is based on graphing methods that have over 40 years of success in a variety of social and human sciences.

The recommended items list may optionally be ranked by averaging preferences across the other customers in the cluster. In step S270, the recommended items list is returned to the application server, and as we have mentioned, there is a huge variety of means to explicitly use the recommendation list, including a variety of means to choose the time and form of recommendations.

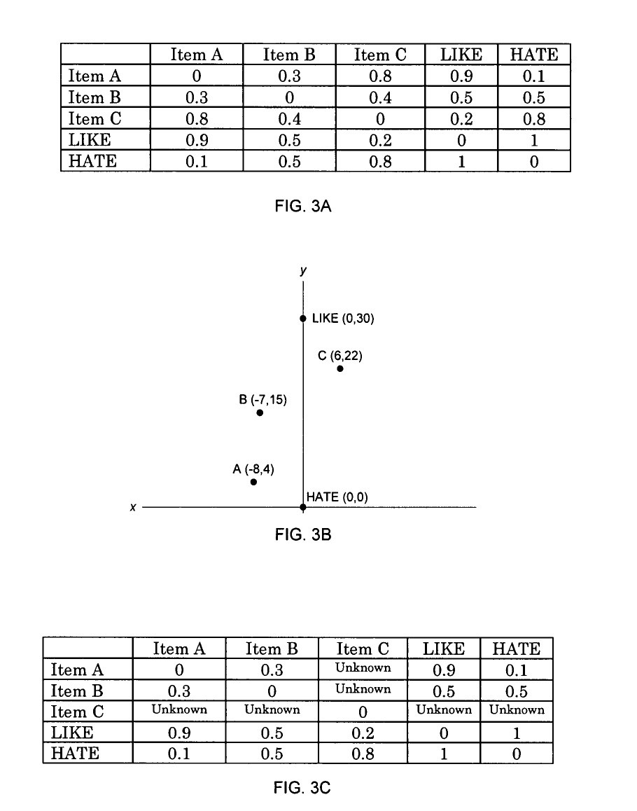

For each customer, a table of relations between music pieces (but it could be as well videos for instance) is stored. In order to store the customer's actual preference for an item, two auxiliary items, “LIKE” and “HATE” are used. FIG. 3A illustrates an example of such a table for three items as well as “LIKE” and “HATE”. The illustrated table uses values ranging from 0 to 1 to express the average time between listening to the two items of music (normalized according to the longer such times for the customer), where a 1 indicates the longest listening time for said customer, or the farthest proximity when at least one of the entities is “HATE” or “LIKE”. Thus, for a given item i, a high value between i and “LIKE” indicates that the customer dislikes the item a great deal and a high value between i and “HATE” indicates that the customer likes the item a great deal. The dissimilarity or similarity for two other (i.e., not both auxiliary) items indicates how dissimilar or how similar the customer considers the items to be. Given what is measured, e.g., an average time between listening to two pieces of music, it is dissimilarity that we are dealing with here. The value on the diagonal, i.e., the dissimilarity of an item i relative to itself, is always 0 when one considers dissimilarities. The value on the diagonal, i.e., the similarity of item i relative to itself, would always be 1 (or whatever the maximum similarity value is) if one would consider similarities instead. In the illustrated example (see FIGS. 3A and 3B), the numbers represent dissimilarity. Thus the customer whose taste is represented considers items A and B to be just a bit more than barely dissimilar, considers A and C to be very dissimilar, and considers B and C to be somewhat dissimilar (and more so than A and B). Also, the customer dislikes item A quite a bit, is indifferent about item B, and likes item C. Note that the triangle inequality does not apply to the illustrated example. I.e., if ∂(i,j) is the value of the table for row i and column j, note that in the example, ∂(1,3)>∂(1,2)+∂(2,3). Also, for all i,j it is the case that ∂(i,j)=∂(j,i). It should be understood that regardless of the range of values chosen for the table, a similar property will hold. Thus, only half of the table needs to be stored (in fact a bit less since once one chooses to interpret the results as similarities or dissimilarities, the diagonal elements are determined). FIG. 3B displays an SSA output corresponding to the relations expressed in FIG. 3A. FIG. 3C illustrates another example table, in which there is almost no known information about the customer's feelings towards item C. In practice, an unknown value can be represented by some special value outside of the given range of preferences. In the illustrated table, for example, an unknown preference might be represented by −1, which is outside of the range of 0 to 1. One may prefer to leave unspecified the values corresponding to unknown relations. In fact, they might be mostly determined by what is known and the methods of this invention may help determine that better than the prior art. In practice, one would not incorporate the pairs with unknown mutual relation in the expression of the strain. It should also be understood that for applications where the preference tables are sparse, i.e., with a large number of unknown values and 0 values, other standard compression techniques may be used to save storage space.

This relations data may be gathered through customer surveys, purchase histories, browsing histories, or other standard techniques. For example, a music recommendation system might gather preferences by monitoring how long customers listen to samples of music and determining a preference for one song over another by comparing the relative time spent listening to the two songs, thus determining the position of various songs with respect to the “HATE” and “LIKE” nodes. Additionally, the mutual relations for pair of songs could come from measuring the average time lapsed between listening to the two pieces for a substantial portion of their lengths (e.g., 90% of the total length of the piece, and managing the possibility that the proportion varies with parameters such as the total length of a song, its genre, etc.). It should be understood that other techniques for gathering relation data are also possible. Further, preferences for specific items may be aggregated over categories of items. For example, a music recommendation system might store individual customers' preferences for genres of music by aggregating preferences of items by item genre, or similarly might store customers' preferences for musical artists by aggregating preferences by musical artist. One aggregation technique is to capture the relation between items by category by averaging over item-wise relations between items of said categories. That is, all of the preferences of items in a first category are related as is done for individual items to items in a second category and these results, besides or instead of being used as such, can be aggregated by averaging all of those individual preferences to determine a single relation value between the first category and the second category. This operation can be performed for all pair-wise combinations of categories in order to create a relation table based on category rather than on individual item.

It should be understood that the techniques of this invention are not limited to recommendation systems. In such cases, a similarity matrix without the auxiliary elements “LIKE” and “HATE” may be used. For example, an application correlating the movements of stocks could simply use the correlation values for the stocks. The relation in that case is correlation, a value that ranges in the interval [−1,1]. In such an embodiment, −1 indicates anti-correlation. Instead of using a value c in [−1,1], one could map this interval affinely to the unit interval, and replace c by c′=(c+1)/2. This is in effect done in some domains of application of SSA. For pricing of securities depending on several underlying securities (such as option on baskets for instance), the invention will be used to simplify the correlation matrix that is often considered as containing redundant and noisy information. To this effect, anti-correlation is a form of extreme proximity up to sign rather than total disconnection as would be the result of using c′ instead of c. Thus one considers absolute values before doing the SSA or MDS representation. Then one extracts a graph from the one-parameter family, and interprets this graph (as is often done) as a matrix of 0 s (meaning no edge) and 1 s (meaning an edge) between the points respectively indexed by the line and column numbers. This 0-1 matrix so obtained is then point-wise multiplied by the original matrix to get a simpler correlation matrix. One can also iterate the process, perhaps with a different value of the parameter, all parameters being fixed by trial and error depending on the actual instruments being priced. Any instance of applicability of SSA, where anti-correlation is a twisted identity rather than absolute separation, would see the use of correlations as described here. In particular, the macroeconomics of the stock market, where one investigates or just tries to have an intuition or a simple representation of exchange correlations (to mention an example) would see the utilization of correlations as we have just explained as being preferred over the use of c′. This applies in particular to the extremely important problems of: market surveillance (for detecting potential good investments or for detecting wrongdoing); network surveillance, including surveillance of traffic of the World Wide Web (WWW) for commercial or efficacy enhancement, and the surveillance of some users of the network (for instance the WWW) and any matter related to security.

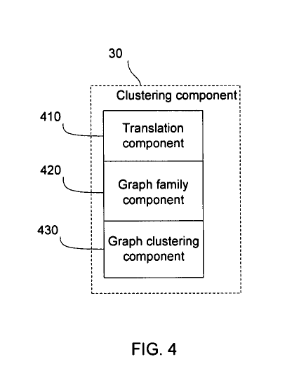

The invention uses the customer pair-wise comparisons tables to identify clusters of customers having similar preferences. FIG. 4 illustrates the clustering component 30, having a translation component 410, a graph family component 420, and a graph clustering component 430. The translation component 410 translates preference tables into sets of points in a geometric space in a way that the values of the preferences are preserved, as discussed below in more detail. The graph family component 420 computes graphs connecting those points such that edges are placed between points that are close together, also as discussed below. Once the graphs for all customers are computed by the graph family component 420, the graph clustering component 430 determines clusters of those graphs based on how similar they are to each other. Because each graph corresponds to a customer and clustering component 430 saves the clusters of graphs it computes, a cluster of graphs can be converted to a cluster of customers. The graph is stored in the cluster database 40, described above in the description of FIG. 1. Instead of directly computing a cluster based on graph comparisons, one can look at all graphs with a given set of vertices, and only look at those graphs for clusters. One can also cluster first for graphs associated to a coarse-graining of the music, as provided for instance by using genres or authors, and then only refine to the piece and even, for customers who are experts, to the various recordings of the music pieces.

In operation, the translation component 410 iterates through the customer relation tables for each customer, and, for each table, produces a set of points that preserves (as much as possible, with a tradeoff between quality and computation time if the dimension of the space where the points live is too small to allow for zero strain) the ordering of the pair-wise relations expressed in the table. These point sets are received by the graph family component 420, which computes, for each point set, a family of graphs. This family of graphs is a range of graphs, ranging from less connected to more connected, where points are connected if, after choosing a parameter value t they are connected in the graph for parameter t, provided by this invention as a function of the parameter t and the configuration of points; the existence of an edge for some t indicates a sort of proximity that is not purely metric but depends on a subtle way upon the Voronoï tiling induced by the set of points, thus essentially preserving the non-exclusively metric nature of the isotonic, or quasi-isotonic, embedding provided by SSA and/or MDS. The family of graphs for each customer, or typically one graph from the family (selected as explained below) for each customer (a customer is used as an index of the graph name), is received by the graph clustering component 430. The graph clustering component 430 identifies similar graphs and groups them into clusters. These clusters of graphs are then converted to clusters of customers (because each graph corresponds to the customer that indexes its name), and the clusters are saved in the cluster database 40.

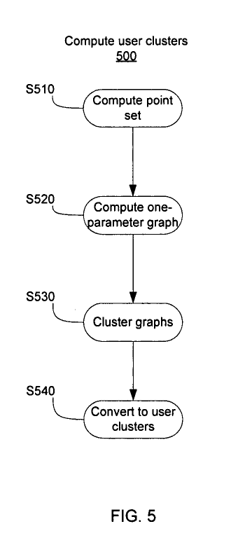

FIG. 5 illustrates a method of computing clusters of customers. In step S510, the pair-wise comparisons tables are translated into sets of points. There are various standard techniques for performing this translation known in the art. For example, the Multidimensional Scaling (MDS) Problem (also known as Similarity Structure Analysis (SSA)) defines a problem of this type. In the Multidimensional Scaling (MDS) Problem, a set of pair-wise relations between items is converted into a set of points in a space in a way that tries to preserve those relations visually. Intuitively, if two items are closely related to each other, they should be close to each other visually. Mathematically, given a set I={i, j, . . . } of items, a dissimilarity relation ∂:I×I→S where S is partially ordered, MDS produces a set of points P⊂ [symbol] ^{δ} for some dimension δ and distance metric d: [symbol] ^{δ}× [symbol] ^{δ}→ [symbol] , where PᵢεP is the point corresponding to the item iεI, such that the constraint
∀i,j,k,lεI ∂(i,j)>∂(l,k) [symbol] d(Pᵢ,Pⱼ)>d(Pₗ,Pₖ)

is satisfied and δ is the smallest dimension satisfying that constraint. This constraint is called the isotony (and sometimes the monotonicity or monotony) constraint. In the above definition, higher “dissimilarity” values between items results in greater distance between the translated points. One can as well use similarity (where more similar pairs of entities map to closer pairs of point to satisfy isotony). In such a case, embodiments of the present invention use the constraint
∀i,j,k,lεI ∂(i,j)>∂(l,k) [symbol] d(Pᵢ,Pⱼ)<d(Pₗ,Pₖ)
The result is the same, i.e., items that are similarly preferred by the customer are closer together in space when isotony is achieved and one gets almost that, or quasi-isotony if the dimension is too small or the algorithm has convergence problems. One can also use a combination of both similarity and dissimilarity where one keeps only one of the two sorts of relations by reinterpreting the other one, thus if similarity is kept, one uses that very dissimilar entities can just as well be considered as poorly similar, while if dissimilarity is kept, one uses that very similar entities can just as well be considered as poorly dissimilar. This is the classical definition of MDS/SSA. For the present invention's purposes, similarity or dissimilarity values are stored, depending on the application, with similarity being used in recommendation of music or videos, except for the special treatment of the “LIKE” and “HATE” entities and corresponding points in the SSA or MDS outputs.

Efficient algorithms for solving the MDS problem are known in the art. See, e.g., W. S. Torgerson, Theory and methods of scaling (1958); C. H. Coombs, A theory of data (1964); F. W. Young and R. M. Hamer, Multidimensional Scaling: History, Theory, and Applications (1987); Roger Shepard, The analysis of proximities: Multidimensional scaling with an unknown distance function I, 27 Psychometrika 125 (1962); Roger Shepard, The analysis of proximities: Multidimensional scaling with an unknown distance function II, 27 Psychometrika 219 (1962); Joseph Kruskal, Multidimensional scaling by optimizing goodness of fit to a nonmetric hypothesis, 29 Psychometrika 1 (1964); Joseph Kruskal & M. Wish, Multidimensional Scaling: Quantitative Applications in the Social Sciences (1978); Louis Guttman, A general nonmetric technique for finding the smallest coordinate space for a configuration of points, 33 Psychometrika 469 (1968) (proposing the term Smallest Space Analysis instead of MDS).

When step S510 is complete, for some q, such as q=2, the translation component produces a set of points P={P₁, P₂ . . . , Pᵣ} in [symbol] ^{q} for each customer pair-wise comparison table. In one embodiment, the set of points is always projected onto 2-dimensional space in order to allow for easier visualization and easier computation of the Voronoï tiling and the family of graphs according to this invention.

In step S520, a family of graphs is constructed for each set P. This graph family is conceptually associated to the Voronoï tessellation but the actual computation uses the generalization of Delone's sphere that helps generate what is classically called the Delone (or Delaunay) graph, where two points generating the Voronoï tiling bound an edge if and only if the closures of their respective Voronoï regions intersect (necessarily then on a convex piece of the boundaries of the two regions). For each set of points in [symbol] ^{q}, say P, the Voronoï tessellation of [symbol] ^{q} determined by P is constructed. For any nonempty set of points F⊂ [symbol] ⁿ, for each point pεF, the Voronoï region (with respect to F) of p, denoted V_{F}(p), is defined to be the set of points which are closer top than they are to any other point in F:
V_{F}(p)={xεⁿ:∀p′εF,d(x,p)≦d(x,p′). (EQ. 1)

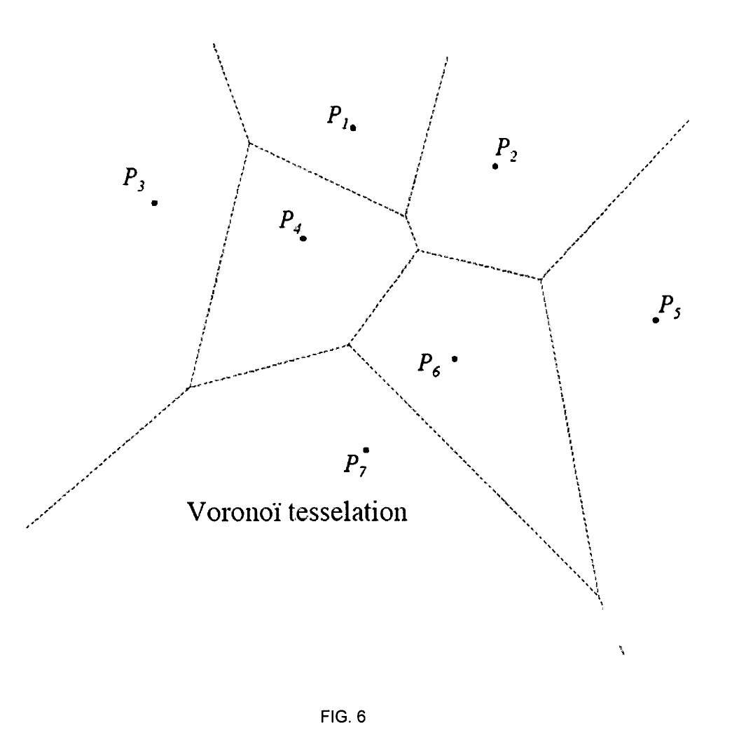

An arbitrary rule (that can be chosen as deterministic or random) is used to break ties, such that each point xε [symbol] ⁿ is contained in exactly one Voronoï region determined by the points of F. The Voronoï tessellation (associated to or induced by F) is then the partition of [symbol] ⁿ into the Voronoï regions determined by the points in F. FIG. 6 shows a finite set with seven points and the associated Voronoï tessellation. The construction of the Voronoï tessellation may be accomplished by standard techniques, such as Fortune's algorithm. For more information regarding Voronoï tessellations and the computational aspects, in particular when q=2, see F. P. Preparata and M. I. Shamos, Computational Geometry: An Introduction (1985). For a thorough review that cover the classical work related to Delone graphs, Gabriel graph, and some partial parameterized families associated to Voronoï tessellations, we refer to A. Okabe, B. Boots, K. Sigihara, S. N., Chiu, and K. Sugihara, Spatial tessellations: Concepts and Applications of Voronoï Diagrams (2d ed. 1992).

Returning to FIG. 5, two graphs constructed from the Voronoï tessellation induced by F are particularly important. The Gabriel (or strong) graph of F has vertex set F with an edge relation that joins two points in F⊂ [symbol] ⁿ if and only these two vertices belong to neighboring Voronoï regions with respect to F, and the straight line segment between them is contained in the union of their two Voronoï regions. The Delone (or weak) graph of F (also spelled “Delaunay graph”) has vertex set F (or F∪{∞}) and is obtained by joining two points if and only if the Voronoï regions of these points share a piece of boundary.

Embodiments of the present invention define and use a family of one-parameter graphs Gₜ(P) such that G₀(P) is the Gabriel graph of the Voronoï tessellation induced by P, G₁(P) is the Delone (or Delaunay) graph of the Voronoï tessellation induced by P, and
x≦y [symbol] Gₓ⊂G_{y}. (EQ. 2)

Two alternative characterizations of the Gabriel and Delone graphs will be used in constructing the family of one-parameter graphs. As above, let P={P₁, P₂, . . . , Pᵣ} be the points produced by the SSA/MDS component, such that P⊂ [symbol] ⁿ for some n. The pair (Pᵢ,Pⱼ) is an edge of the Gabriel graph G₀(P) if and only if the line segment [Pᵢ,Pⱼ] does not intersect the interior of the Voronoï region Vₚ(Pₖ) for any point PₖεP other than Pᵢ or Pⱼ. The Delone graph G₁(P) is obtained by declaring as edges all pairs in a (n+1)-tuple (Pₐ_{₁}, Pₐ_{₂}, . . . , Pₐ_{ₙ₊₁}) of points from P that do not belong to a strict subspace of [symbol] ⁿ and belong to a sphere so that the closure of the ball in that sphere does not contain any other point PₖεP, i.e. no other point belongs to the closed ball whose bounding sphere is circumscribed to these (n+1) points. Note that an edge of these graphs can be realized as the geometric line segment connecting the two vertices of the edge for values of t between 0 and 1, as well of course as for t<0.

We recall that the interior of a sphere along with the sphere is the “closed ball” or “ball” determined by the sphere. Thus, (Pᵢ,Pⱼ)εG₀(P) if and only if the ball bounded by the sphere with diameter [Pᵢ,Pⱼ] does not contain any other point of P. Furthermore, (Pᵢ,Pⱼ)εG₁(P) if and only if there is a sphere that contains Pᵢ, Pⱼ, and exactly n−1 other points of P, and no point of P is in the ball that is bounded by this sphere.

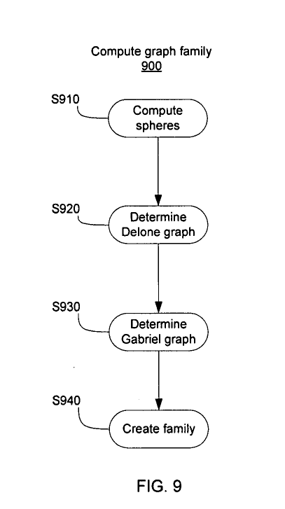

If of the points of P there are more than n+1 points on a sphere but none in the interior of the closed ball bounded by this sphere, this is a marginal situation and it is then necessary to look more carefully if the links are through faces of the Voronoï regions that have dimension n−1 rather than some smaller dimension. The links that really count and that should belong to the Delone graph are those which resist generic small perturbations, either of the path between the elements of P or of the coordinates of the points. Both points of view lead to straightforward algorithms to determine the graph. See also below the discussion of FIG. 9.

Embodiments of the present invention define a family of graphs “between” the Gabriel and the Delone graphs, i.e., between graphs G₀(P) and G₁(P), although a wider range for t values may be used for some applications, in particular to keep control on handling cost when the number of vertices is very large. Embodiments of the present invention define graphs Gₜ(P) where 0≦t≦1 and for each t, G₀(P) is a subgraph of Gₜ(P) and Gₜ(P) is a subgraph of G₁(P). Further, for all t₁,t₂, if t₁≦t₂ then Gₜ_{₂}, is a subgraph of Gₜ_{₂}. Embodiments of the present invention define a \tilde{ρ}(P)≦1 such that G_{\tilde{ρ}(P)}(P)=G₁(P). If the segment [Pᵢ,Pⱼ] is part of the Delone graph G₁(P), then there is (at least) one point Q_{i,j} that is closest to [Pᵢ,Pⱼ] among the points that are in the median hyperplane of [Pᵢ,Pⱼ], and such that Q_{i,j} is at least as close to Pᵢ or Pⱼ as it is to any other point in P.

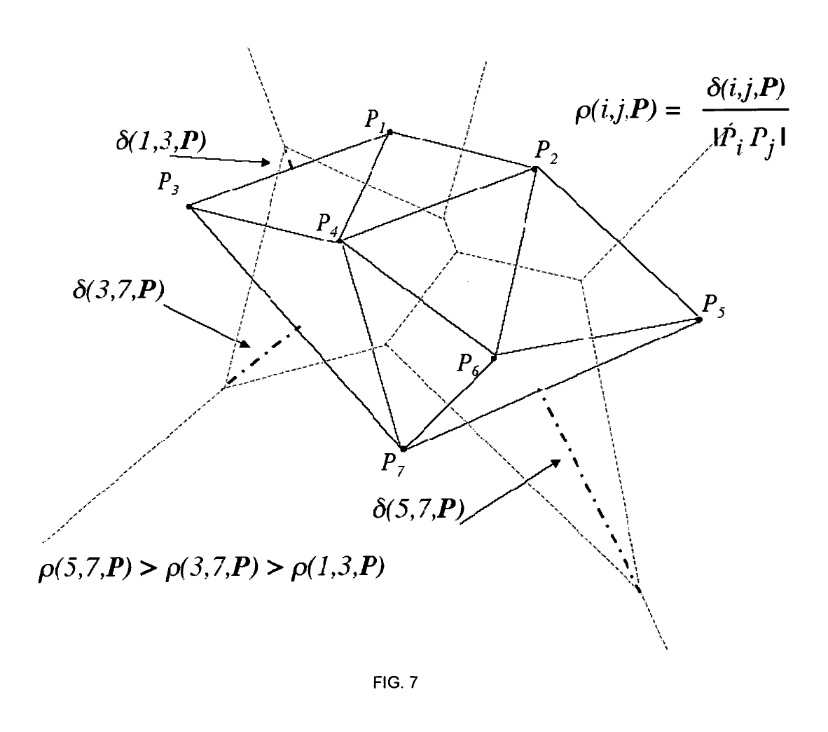

Then, δ(i,j,P) is the distance from Q_{i,j} to the segment [Pᵢ,Pⱼ]. Consequently, ρ(i,j,P) may be defined as follows:

$$ρ ( i , j , P ) = \frac{δ ( i , j , P )}{\vert {P}_{i} , {P}_{j} \vert} \qquad ( EQ . 3 )$$

where |Pᵢ,Pⱼ| is the length of the segment [Pᵢ,Pⱼ]. FIG. 7 illustrates δ(i,j,P) and ρ(i,j,P) for a two-dimensional example. Notice that δ(i,j,P) is in fact the distance between Q_{i,j} and the midpoint of [Pᵢ,Pⱼ], because the midpoint is the intersection of [Pᵢ,Pⱼ] with the median hyperplane that also contains Q_{i,j}. This will be clear from the more precise description of Q_{i,j} discussed below.

Next, \tilde{ρ}(P), the graph family parameter, may be defined to be the maximal value of ρ(i,j,P) taken over all segments [Pᵢ,Pⱼ] belonging to G₁(P). That is,

$$\tilde{ρ} ( P ) = {sup}_{[ {P}_{i} , {P}_{j} ] ∈ {G}_{1} ( P )} ρ ( i , j , P ) \qquad ( EQ . 4 )$$

There is then a family of geometrical graphs Gₜ(P), 0≦t≦1, that interpolates between G₀(P) and G₁(P), such that the segment [Pᵢ,Pⱼ] is part of the graph Gₜ(P) if and only

$$if \frac{ρ ( i , j , P )}{\tilde{ρ}} \leq t .$$

It is convenient to renormalize so that 0≦t≦1. In particular, ρ(i,j,P)=0 if and only if [Pᵢ,Pⱼ] is part of the Gabriel graph G₀(P). The behavior at t=1 on the other hand is limited by using the quotient by the maximal value \tilde{ρ}(P).

If needed, one can further extend the parameter range beyond t=1. In general, for any Pᵢ and Pⱼ, then any path from between Pᵢ and Pⱼ of a given length L will be such that L=L(in)+L(out) where L(in) is the length of that part of the path contained within the union of the Voronoï regions of Pᵢ and Pⱼ and L(out) the length of that portion outside those regions. Consider the path that minimizes L(out). Then either L(out)>0 or the points Pᵢ and Pⱼ are the vertices of an edge in the Delone graph. If the points Pᵢ and Pⱼ are not the vertices of an edge in the Delone graph, then the number t_{i,j}=min[L(out)]+1 is then an example of the minimal parameter value for which the pair (Pᵢ,Pⱼ) belongs to the parameter dependent graph. Note that one can use instead a normalized minimal length in which L is computed by dividing by the distance |Pᵢ,Pⱼ|.

Similarly, one can extend the parameter range below t=0, for example, by letting Pᵢ,Pⱼ be excluded from Gₜ for those values of t below some value of the parameter t_{i,j} defined as follows: let L denote the length of the longest edge of G₀.

$$Then {t}_{i , j} = \frac{\vert {P}_{i} , {P}_{j} \vert - L}{L} .$$

It should be understood that it is course possible to find some other way of suppressing edges for values below t=0. For example, one could use

$${t}_{i , j} = \frac{\vert {P}_{i} , {P}_{j} \vert - L}{L \cdot max ( val ( {P}_{i} ) , val ( {P}_{j} ) )} ,$$

where val(Pₖ) stands for the number of nodes linked to Pₖ in the Delone graph.

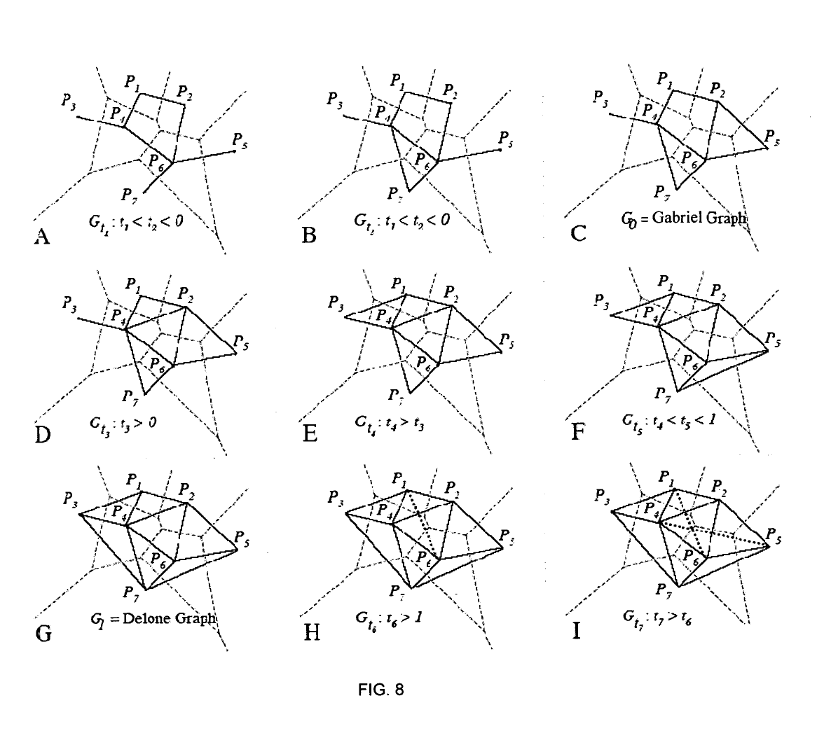

FIG. 8 illustrates part of the one-parameter family of graphs Gₜ(P) as described according to this invention has been illustrated for the planar finite set P={P₁, P₂, . . . , P₇}. The parameter is normalized so that G₁(P) is the Delone graph. The family has been extended below 0 and above 1, with links that appear when t>1 indicated by dotted lines. The parameter t increases from panel A to panel I. The construction of the one-parameter family of graphs is discussed in more detail below.

Returning to FIG. 5, once step S520 has been completed, there is a one-parameter family of graphs created for each customer. In step S530, clusters of graphs are identified. Because each customer has a family of graphs Gₜ(P), as explained above, normally one value of t is chosen across all customers (or a rule to choose t is chosen so that the parameter value is well-defined for each customer but depends on the customer). Thus, each customer has exactly one graph Gₜ(P) associated to him or her assuming that only one parameter value is used. Alternatively, step S530 could be performed once for each value of t in some finite set of values of the parameter t. The value of t is fixed such that the clusters produced are balanced in size, or based on some other desired characteristic, or the value of t may be chosen at random or by some other technique. Trial and error will sometime be chosen as the method to fix the parameter in a given embodiment of this invention.

Clustering points in space is known in the art. For example, the K-means algorithm may be used to cluster data points. As long as there is a distance measure between two points, clusters can be computed. In the case of the graphs Gₜ(P), any standard distance measure for measuring graph similarity may be used. For example, the Hamming distance defines the distance between two graphs as the total number of points appearing in only one of the two graphs plus the total number of edges appearing in only one of the two graphs. One can also give different weights to edges and vertices rather than the same weights in the Hamming distance. Given a distance between graphs, the graphs Gₜ(P) are clustered using a standard clustering algorithm known in the art, such as the K-means algorithm. Once step S530 is complete, clusters of graphs have been identified. In step S540, the graph clusters are translated into clusters of customers. Because each graph corresponds to one customer (i.e., the customer whose data are used to compute said graph), this translation is straightforward. The clusters of customers are then saved to the cluster database.

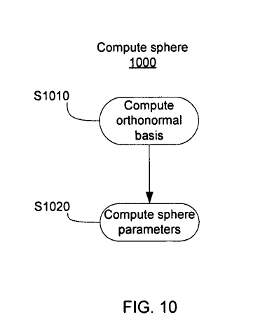

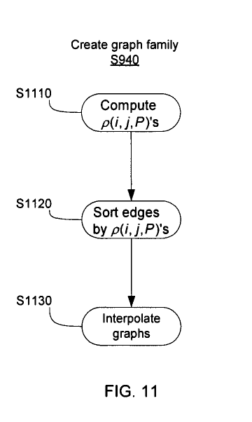

FIG. 9 illustrates a method of computing the graph family for a set of points P, which corresponds to the Voronoï tessellation determined by P, computed as explained above. Recall that P⊂ [symbol] ^{q} for some q. In step S910, spheres are computed for every m-tuple of points in P, for m=q+1. The sphere computed has each point in the m-tuple on its surface. The method for computing a sphere, given an m-tuple, is explained below in the discussion of FIG. 10. Once these spheres have been computed, in step S920, the Delone graph is determined. This is done by examining each sphere to determine if any points of P that are not in the m-tuple are contained in the closed ball that it bounds. If the closed ball bounded by the sphere is empty of further points, the m-tuple of points that generated it and all edges between the pairs of points in the m-tuple (i.e., the simplex for the m-tuple of points) form a chunk of the triangulation in the Delone graph, and the simplex for the m-tuple of points is added to the Delone graph. It is either the uniqueness of the triangulation or the fact that there is a triangulation that has to be let go in the degenerate case when the open ball bounded by the sphere the m-tuple of points is empty but points that are not in the m-tuple belong to the sphere; some choice has to be made, for instance at random, to get a Delone triangulation. More precisely, if the m-tuple generates a sphere such that the open ball that it bounds is empty, but for some m′>0, m+m′ points belong to the sphere, then there are many ways to split the m+m′ points into m-tuples that determine simplexes with pair-wise disjoint interiors. One can then either associate edges to all pieces of graphs corresponding to these simplexes, after making any choice of decomposition into simplexes, or make no choice, but rather consider all of the full graphs on the m+m′ points as part of the Delone graph. It is in general the first option, preserving triangulation at the cost of uniqueness (hence using some arbitrariness), that will be taken in the invention, as the other approach would not permit the construction of the one-parameter family of graphs. If only the Delone graph is expected to be used, one could take the second option. If now one only wants edges that resist perturbation, as discussed previously when the ambiguous case was first mentioned, all links that come only from degenerate cases should be ignored. In the worst case, in which the use of spheres of the highest possible dimension still leaves some ambiguity, one uses only spheres whose parameters are obtained by considering lower dimensions, using the construction that we describe to find the parameters associated to the various edges. In case of such degeneracy, the Delone graph would be defined as the union of the graphs generated by using lower-dimensional spheres. For instance in two dimensions, four points at the corners of a rectangle would yield the sides of the rectangle as the only edges of the Delone graph for these four points if one wants only stable links. As a simple example with no degeneracy, if q=2, three edges would be added for each sphere (then a circle) that bounds a ball (then a disk) with empty closure except for the three point defining the circle. By definition, this method will produce the Delone graph, i.e., G₁(P). Once the Delone graph is computed, in step S930, the Gabriel graph, i.e., G₀(P) is computed. This is accomplished by first performing step S910 for every (m−1)-tuple of points such that the (m−1)-tuple belongs to some triangulation of the Delone graph. That is, spheres are computed for all such (m−1)-tuples of points. As in step S920, these spheres are checked to see if the closed balls that they bound are empty. If a closed ball is empty, the edges of the fully connected graph with all points in the (m−1)-tuple as set of vertices are added to the Gabriel graph, tossing out any duplicates. For example, if q=2, a pair of points would be added if the line segment connecting them is the diameter of a circle containing no other points of P. By definition, this method produces the Gabriel graph, i.e., G₀(P). In step S940, the graphs between G₀(P) and G₁(P) are computed, as explained below in the discussion of FIG. 11.

FIG. 10 illustrates a method of computing a sphere, given a tuple of points. Consider a collection of points P={P₁, P₂, . . . , Pₖ},P⊂ [symbol] ^{q} for some q. If k−2<q, these points may or may not be included in a (k−2)-dimensional affine subspace of [symbol] ^{q}. (The inclusion is obviously true, but a tautology, if k−2≧q.) Let A(P) stand for the matrix with columns Pᵢ−P₁, for i≠1, so that A(P) is a (k−1) by q matrix. For any increasing list of k−1 numbers i₁<i₂< . . . <iₖ₋₁ in {1, 2, . . . , q}, and any (k−1) by q matrix M, let [i₁, i₂, . . . , iₖ₋₁](M) be the (k−1) by (k−1) matrix obtained by keeping the rows with numbers i₁<i₂< . . . <iₖ₋₁ of M. If
det([i₁,i₂, . . . ,iₖ₋₁](A(P))=0 (EQ. 5)
for all lists iᵢ<i₂< . . . <iₖ₋₁,then P⊂E≡ [symbol] ^{k-2}. Otherwise, i.e., if det ([i₁, i₂, . . . , iₖ₋₁](A(P))≠0 for some list, the k-collection P spans a (k−1)-dimensional affine subspace of [symbol] ^{q}, and it can be said that this collection of k points is non-degenerate. E(P) denotes the affine subspace of [symbol] ^{q} spanned by P.

As explained above for FIG. 9, q>k−2. Let P={P₁, P₂, . . . , Pₖ} be a non-degenerate k-set of points in [symbol] ^{q}. Let S(M(P),L(P)) be the sphere with center M(P) and radius L(P) that contains the points of P.

Continuing with FIG. 10, in step S1010, an orthonormal basis for E(P) is computed. First, k−1 vectors span a (k−1)-dimensional affine space in [symbol] ^{q}, say (\vec{v}₁, \vec{v}₂, . . . , \vec{v}kₖ₋₁), where \vec{v}ᵢ=Pᵢ₊₁−P₁. Next, a new orthonormal basis (\vec{w}₁, \vec{w}₂, . . . , \vec{w}ₖ₋₁) is defined.
Start by setting

$${\vec{w}}_{1} = \frac{{\vec{v}}_{1}}{\vert {\vec{v}}_{1} \vert} . \qquad ( EQ . 6 )$$

Embodiments of the present invention proceed by induction. If the first p−1 vectors (\vec{w}₁, \vec{w}₂, . . . , \vec{w}ₚ₋₁) have been determined, \vec{w}ₚ is a linear combination of the first p−1 vectors and \vec{v}ₚ. That is,
\vec{w}ₚ=a_{p,1}\vec{w}₁+a_{p,2}\vec{w}₂+ . . . +a_{p,p-1}\vec{w}ₚ₋₁+a_{p,p}\vec{v}ₚ (EQ. 7)
for some coefficients a_{p,1}, a_{p,2}, . . . . , a_{p,p}, which must be determined. The orthonormality conditions related to \vec{w}ₚ and the first p−1 vectors mean that the following are true:
∀i<p,\vec{w}ₚ·\vec{w}ᵢ=0
\vec{w}ₚ·\vec{w}ₚ=1
Thus, for i<p,
a_{p,1}\vec{w}₁·\vec{w}ᵢ+a_{p,2}\vec{w}₂·\vec{w}ᵢ+ . . . +a_{p,p-1}\vec{w}ₚ₋₁·\vec{w}ᵢ+a_{p,p}\vec{v}ₚ·\vec{w}ᵢ=0, (EQ. 8)
and
a_{p,1}\vec{w}₁·\vec{w}ₚ+a_{p,2}\vec{w}₂·\vec{w}ₚ+ . . . +a_{p,p-1}\vec{w}ₚ₋₁·\vec{w}ₚ+a_{p,p}\vec{v}ₚ·\vec{w}ₚ=1, (EQ. 9)
which is a system of p linear equations with p unknown quantities a_{p,j} for 1≦j≦p. Since the first p−1 vectors form an orthonormal set, the last equation can be re-written as:

$$\begin{matrix}\begin{matrix}\begin{matrix}\begin{matrix}{a}_{p , 1} {\vec{w}}_{1} \cdot ( {a}_{p , 1} {\vec{w}}_{1} + {a}_{p , 2} {\vec{w}}_{2} + ⋯ + {a}_{p , p - 1} {\vec{w}}_{p - 1} + {a}_{p , p} {\vec{v}}_{p} ) + \\ {a}_{p , 2} {\vec{w}}_{2} \cdot ( {a}_{p , 1} {\vec{w}}_{1} + {a}_{p , 2} {\vec{w}}_{2} + ⋯ + {a}_{p , p - 1} {\vec{w}}_{p - 1} + {a}_{p , p} {\vec{v}}_{p} ) +\end{matrix} \\ … +\end{matrix} \\ {a}_{p , p - 1} {\vec{w}}_{p - 1} \cdot ( {a}_{p , 1} {\vec{w}}_{1} + {a}_{p , 2} {\vec{w}}_{2} + ⋯ + {a}_{p , p - 1} {\vec{w}}_{p - 1} + {a}_{p , p} {\vec{v}}_{p} ) +\end{matrix} \\ {a}_{p , p} {\vec{v}}_{p} \cdot ( {a}_{p , 1} {\vec{w}}_{1} + {a}_{p , 2} {\vec{w}}_{2} + ⋯ + {a}_{p , p - 1} {\vec{w}}_{p - 1} + {a}_{p , p} {\vec{v}}_{p} ) = 1\end{matrix} \qquad ( EQ . 10 )$$

which simplifies to

$$\begin{matrix}{a}_{p , 1}^{2} + {a}_{p , 1} {a}_{p , p} {\vec{w}}_{1} \cdot {\vec{v}}_{p} + {a}_{p , 2}^{2} + {a}_{p , 2} {a}_{p , p} {\vec{w}}_{2} \cdot {\vec{v}}_{p} + ⋯ + \\ {a}_{p , p - 1}^{2} + {a}_{p , p - 1} {a}_{p , p} {\vec{w}}_{p - 1} \cdot {\vec{v}}_{p} + \\ {a}_{p , p} {\vec{v}}_{p} \cdot ( {a}_{p , 1} {\vec{w}}_{1} + {a}_{p , 2} {\vec{w}}_{2} + ⋯ + {a}_{p , p - 1} {\vec{w}}_{p - 1} + {a}_{p , p} {\vec{v}}_{p} ) = 1\end{matrix} \qquad ( EQ . 11 )$$

or in summation form:

$${\sum }_{i = 1}^{p - 1} {a}_{p , i}^{2} + 2 ( {\sum }_{i = 1}^{p - 1} {a}_{p , i} {a}_{p , p} {\vec{w}}_{i} \cdot {\vec{v}}_{p} ) + {a}_{p , p}^{2} {\vert {\vec{v}}_{p} \vert}^{2} = 1 \qquad ( EQ . 12 )$$

Because for iε{1, 2, . . . , p−1}, \vec{w}ₚ·\vec{w}ᵢ=0,
a_{p,i}+a_{p,p}\vec{v}ₚ·\vec{w}ᵢ=0, (EQ. 13)
the equation can be solved for a_{p,i} to get
a_{p,i}=−a_{p,p}\vec{v}ₚ·\vec{w}ᵢ. (EQ. 14)
Then substituting the a_{p,i}'s, the following equation is produced:

$$\begin{matrix}{\sum }_{i = 1}^{p - 1} {( - {a}_{p , p} {\vec{v}}_{p} \cdot {\vec{w}}_{i} )}^{2} + 2 ( {\sum }_{i = 1}^{p - 1} ( - {a}_{p , p} {\vec{v}}_{p} \cdot {\vec{w}}_{i} ) {a}_{p , p} {\vec{w}}_{i} \cdot {\vec{v}}_{p} ) \\ + {a}_{p , p}^{2} {\vert {\vec{v}}_{p} \vert}^{2} = 1\end{matrix} \qquad ( EQ . 15 )$$

which simplifies to:

$${a}_{p , p}^{2} ( {\vert {\vec{v}}_{p} \vert}^{2} - {\sum }_{i = 1}^{p - 1} {( {\vec{v}}_{p} \cdot {\vec{w}}_{i} )}^{2} ) = 1. \qquad ( EQ . 16 )$$

This equation is solved for a_{p,p} to get:

$${a}_{p , p} = \frac{1}{\sqrt{{\vert {\vec{v}}_{p} \vert}^{2} - {\sum }_{i = 1}^{p - 1} {( {\vec{v}}_{p} \cdot {\vec{w}}_{i} )}^{2}}} . \qquad ( EQ . 17 )$$

This formula (EQ. 17) for a_{p,p} can be used to determine the a_{p,i}'s, as explained above. These coefficients are then used to determine \vec{w}ₚ. This same method is used to determine the rest of the vectors in the orthonormal basis.

Continuing with FIG. 10, in step S1020, the parameters of the sphere are computed. The formulas obtained above to get the orthonormal basis of the \vec{w}ᵢ are used to express the points of P in that basis. Recall that the vectors \vec{v}₁, \vec{v}₂, . . . \vec{v}ₖ₋₁ are defined in terms of the points of P, i.e., \vec{v}ᵢ=Pᵢ₊₁−P₁. From the above definition of \vec{w}₁,
P₂−P₁≡\vec{v}₁=|\vec{v}₁|\vec{w}₁. (EQ. 18)
From there, the formulas obtained above for the vector coefficients can be used to obtain inductively:

$${P}_{i} - {P}_{1} ≡ {\vec{v}}_{i} = \frac{{\vec{w}}_{i} - ( {a}_{i , 1} {\vec{w}}_{1} + {a}_{i , 2} {\vec{w}}_{2} + … + {a}_{i , i - 1} {\vec{w}}_{i - 1} )}{{a}_{i , i}} \qquad ( EQ . 19 )$$

Thus, k points P={Q₁=0, Q₂, . . . , Qₖ} are spanning a (k−1)-dimensional space. These points, whose coordinates q_{i,j} with 1≦i≦k and 1≦j<k and q_{1,j}=0 are expressed in some orthonormal basis with Q₁ at the origin. They are the corners of a simplex and belong to a unique sphere, S(M(P),L(P)). Note that the points in P lie on the surface of S(M(P),L(P)), and therefore each point in P is equidistant from M(P), the center of the sphere. That is,
|M(P)|²=|Q₂−M(P)|²=|Q₃−M(P)|²= . . . =|Qₖ−M(P)|² (EQ. 20).
Abbreviating M(P)=(m₁, m₂, . . . , mₖ₋₁) as M and L(P) as L for the present computation, the equation can be rewritten as:

$$∀ i ∈ \{ 2 , 3 , … , k \} , {\sum }_{j = 1}^{k - 1} {m}_{j}^{2 } = {\sum }_{j = 1}^{k - 1} {( {q}_{i , j} - {m}_{j} )}^{2} . \qquad ( EQ . 21 )$$

Because the origin, Q₁, is on the surface of the sphere, the length of the vector M is equal to the radius L. That is,

$${L}^{2} = {\sum }_{j = 1}^{k - 1} {m}_{j}^{2 } . \qquad ( EQ . 22 )$$

Thus, it is only necessary to determine the mᵢ's in order to determine the sphere. Substituting the definition of L, we get that

$$\begin{matrix}∀ i ∈ \{ 2 , 3 , … , k \} {L}^{2} = {L}^{2} + {\vert {Q}_{i } \vert}^{2} - 2 {\sum }_{j = 1}^{k - 1} {m}_{j} {q}_{i , j} \\ and thus \text{:} & ( EQ . 23 ) \\ ∀ i ∈ \{ 2 , 3 , … , k \} {\sum }_{j = 1}^{k - 1} {m}_{j} {q}_{i , j} = \frac{{\vert {Q}_{i } \vert}^{2}}{2} . & ( EQ . 24 )\end{matrix}$$

We recall here for the ease of the reader, that the mᵢ's are defined by M(P)=(m₁, m₂, . . . , mₖ₋₁), hence as the coordinates of the center of the sphere S(M(P),L(P)). Then, \vec{Q2} is the vector with coordinates

$$( \frac{{\vert {Q}_{2 } \vert}^{2}}{2} , \frac{{\vert {Q}_{3 } \vert}^{2}}{2} , … , \frac{{\vert {Q}_{k} \vert}^{2}}{2} ) ,$$

forming a system of k−1 linear equations with k−1 unknowns. The matrix Q=((q_{i,j})) for i>1 has a nonzero determinant because P, or equivalently the set of vectors \vec{Q}ᵢ=(q_{i,1}, q_{i,2}, . . . , q_{i,k-1}), spans a k−1-dimensional space. Hence,

$${m}_{i} = \frac{\vert [ {\vec{Q}}_{i} \to \vec{Q 2} ] ( Q ) \vert}{\vert Q \vert} . \qquad ( EQ . 25 )$$

Here we have used the notation [\vec{v}ᵢ→\vec{w}](M) to denote the matrix obtained from M by replacing the i^{th} column vector by vector w, while |M| stands for the determinant of matrix M. The minimal distance allowing from Qₚ to Qᵣ without going through a third Voronoï region is thus given by:

$$- \sqrt{( {\sum }_{j = 1}^{k - 1} {( {q}_{p , j} - {q}_{r , j} )}^{2} )}$$

if [Qₚ,Qᵣ] is a link in the Gabriel graph, G₀(P), for P;
−2L(P) otherwise.

This long elementary computation should not make one lose sight of what is most important. First, if two points Qₚ and Qᵣ do not belong to the Delone graph, as decided by using (Delone's) (q−1)-dimensional spheres, then they are not joined by an edge in any graph with parameter t for t≦1. More generally, the family Gₜ constructed here is such that if u is smaller than v, then the graph Gᵤ⊂Gᵥ. Second, if two points Qₚ and Qᵣ do belong to the Delone graph, as decided by using (Delone's) (q−1)-dimensional spheres, then to find the smallest parameter value for which these points bound an edge, one first looks at the lowest dimensional, say w-dimensional, sphere determined by Qₚ and Qᵣ and w other points among those defining the same Delone sphere and such that the closure of the ball bounded by that sphere in the minimal subspace containing that sphere does not contain further points. If now the closed sphere with same center and same radius in the full q-space is also empty of extra points, then twice the radius of said ball is the minimal length of a path joining Qₚ and Qᵣ without quitting the union of their Voronoï regions, otherwise, one has to increase w. The distance from the center of the ball with minimal w to the segment from Qₚ to Qᵣ divided by the distance between Qₚ and Qᵣ divided by the biggest such number for all pairs of points in some Delone sphere is a number associated to Qₚ and Qᵣ that is the minimal value of t such that Qₚ and Qᵣ bound an edge.

We notice that if w is zero, the points Qₚ and Qᵣ bound an edge in the Gabriel graph, and also that the number associated to Qₚ and Qᵣ as just described is indeed zero.

FIG. 11 illustrates a method of creating the graph family, i.e., computing the graphs between G₀(P) and G₁(P). In step S1110, ρ(i,j,P), defined above, is computed for every pair of points Pᵢ and Pⱼ in P such that [Pᵢ,Pⱼ] is an edge of G₁(P) but not G₀(P). Recall that

$$ρ ( i , j , P ) = \frac{δ ( i , j , P )}{\vert {P}_{i} , {P}_{j} \vert} \qquad ( EQ . 26 )$$

where δ(i,j,P) is the distance from a point Q_{i,j} to the midpoint of [Pᵢ,Pⱼ], where Q_{i,j} is at least as close to Pᵢ or Pⱼ as it is to any other point in P. By definition, [Pᵢ,Pⱼ] is an edge of the Delone graph, and thus Pᵢ and Pⱼ belong to an m-tuple defining a sphere such that the closure of the ball that it bounds is empty of points that are in P but do not belong to the m-tuple, as discussed above. The center of this sphere, which was computed above, satisfies the conditions of Q_{i,j}. Thus, given the sphere, ρ(i,j,P) can be computed. In step S1120, all of the edges [Pᵢ,Pⱼ] for which ρ(i,j,P) was computed are sorted by the value of ρ(i,j,P). Define \tilde{ρ}(P) to be the largest value of ρ(i,j,P). In step S1130, the graphs Gₜ(P), 0<t<1 are interpolated. First, the edge [Pᵢ_{₁},Pⱼ_{₁}] with the smallest value of ρ(i₁,j₁,P) is added to graph Gₜ_{₁}(P), where

$${t}_{1} = \frac{ρ ( {i}_{1} , {j}_{1} , P )}{\tilde{ρ} ( P )} . \qquad ( EQ . 27 )$$

Because [Pᵢ_{₁},Pⱼ_{₁}] is not in the Gabriel graph, by definition ρ(i₁,j₁,P)>0, and so t₁>0. The remainder of the list of edges is processed the same way, walking the list in sorted order from smallest to largest. This guarantees that for any tₖ and tₗ, k<l [symbol] tₖ<tₗ. If any two or more edges should happen to have the same value for ρ(i,j,P), all of the edges are added together.

In J. B. Kruskal and J. B. Seery, “Designing network diagrams”, Proceedings of the First General Conference on Social Graphics 22, U.S. Department of the Census, Washington, D.C. (July 1980), Technical Paper No. 49, it is proposed to use MDS to place the vertices of a graph (understood as a topological or a combinatorial object) in the plane so that the geometrical realization of the graph is as understandable, and in particular hopefully, as free of edges crossing as possible. This is important for the purpose of having nice outputs of the present invention when the output is a graph that needs to be easy to read like in the aspects of the recommendation applications when people explore the tastes of other people in their communities or when one wants to have a readable representation of the correlation between stocks or between exchanges, to just name a few. We notice that if the embedding dimension for the output of SSA or MDS is two, and as long as the parameter t is not greater than 1, then the graphs produced according to this invention are planar (i.e., have a geometric embedding in the plane with no pair-wise crossing of edges), and furthermore, such a nice (crossing-less) representation of the graph is provided by the construction that has been presented here. When the embedding dimension n of the output of SSA or MDS is greater than 2, or when it is 2 but t>1, it will happen that the graphs produced are not planar. Furthermore, if n>3, the graph may well be planar, something that is difficult to decide computationally, but it remains to find a planar drawing of it, with either no, or at most a few, crossings and some way to use the fact that any graph lives on some compact surface S_{g}, the compact surface with genus g.

As explained in the cited work of Kruskal and Seery, being able to get nice graph representations has important applications in areas such as:

a) the general problem of graph design (that has great importance in the life of a firm, e.g., to represent all sorts of flows, from the flow of decisions to the flows of money, material, products and other outputs, etc.);

b) electric circuit design, as the planarity of a circuit (either partial or complete) is what enables the circuit to be printed; and

c) as explained above, the quality of the outputs of the invention.

These three reasons motivate one to go beyond the work of Kruskal and Seery, as we explain next. This is not a general solution, because the problem of finding a planar realization of a planar graph is known to be NP-complete.

The way Kruskal and Seery attach dissimilarity to pairs of vertices of a graph G is as follows:

∂(i,j)=1 if the elements indexed by i and j are connected on the graph, and

∞ otherwise.

One then defines a matrix M(G) associated to G by setting:

M_{i,j}=1 if and only if ∂(i,j)=1, and

M_{i,j}=0 otherwise.

We propose here to use a different form of dissimilarity that takes into account secondary links between pairs of points. Of course, the precise form of this measure is not critical and we could use any measure of the dissimilarity between i and j that has the property that it is inversely proportional to some reasonable measure (i.e., a measure that is not “all or nothing” as in the work of Kruskal and Seery) of how two points are connected (in this case the measure is in terms of number of paths).

[1] Start with the 0-1 adjacency matrix Q=Q(G) of the graph G (from its definition, it is plain that this matrix is symmetrical).

[2] Consider successive powers of the matrix Q and define m as the smallest power such that Q^{m+p} has the same non-zero elements as the matrix Q^{m} for some period p>0.

[3] We set ∥M∥=q²·max_{i,j}|M_{i,j}| for a q by q matrix.

[4] The dissimilarity matrix d_{G(i,j)} is now defined as follows:

(a) For all i, d_{G(i,i)}=0.

(b) For all i and j, i≠j, if i and j are connected by at least a path, we place (i,j)εC and set

$${d}_{G ( i , j )} = {( {Q}_{i , j} + {\sum }_{k = 2}^{2 q} {Q}_{i , j}^{k} \cdot {‖ {Q}^{k} ‖}^{- k} )}^{- 1} .$$

(c) For all i and j, i≠j and (i,j)∉C, d_{G(i,j)}≡d_{G,1}=f ·d_{G,0} where d_{G,0}=max_{(i,j)εC}(d_{G(i,j)}) and f>1 is a factor that can be chosen as 2 (or more in order to better separate the connected components of the Delone graph for the SSA or MDS representation of the matrix of similarities).

From the matrix of dissimilarities obtained as described above from the incidence matrix of a circuit (or any graph for this matter since what we do for circuits can as well be applied to the general graph layout problem) we may now generate an SSA or MDS configuration of points in some dimension n. As in other embodiments of the invention, the dimension n can be chosen for economy in computation, or to get more isotony, or to satisfy some tradeoff between these objectives. The output of the general method according to this invention then enables us to associate one or more members of a one-parameter family of graphs associated to the Voronoï diagram associated to the MDS/SSA configuration. We now separate out several cases.

If, for MDS/SSA representation of dimension 2, for some value t of the parameter with t≦1, the graph Gₜ for the SSA/MDS output contains all the edges of the graph for the incidence matrix of the circuit, nothing else needs to be done to get a planar representation of the circuit (except for aesthetic considerations and labeling properly the vertices).

If, for MDS/SSA representation of dimension 2, there exists no parameter t≦1 such that Gₜ exhausts all the edges needed to represent the connections of the circuit, but for some parameter t>1 we obtain all the needed links (or more as undesired links can easily be erased) without crossing, then one would use such a value of t with n=2, and erase the links that do not represent any connection of the circuit.

The last case is where, for all parameter values, every planar representation (dimension 2) is such that all the connections of the circuit are present in the corresponding graph Gₜ but all graphs have crossings (something that is bound to happen in some cases from well known arguments from graph theory). After choosing a configuration with a number of crossings that is minimal or at least seems to be close to minimal, one can then increase the genus of the surface on which the points lie by adding a handle to undo each crossing, until one gets a representation of Gₜ as a graph on a surface of some genus g>1.

The minimal genus g′ needed to resolve all crossings may be bigger than the genus g of the graph (classically defined as the genus of the surface on which the graph can be drawn with no crossing). However, one can then use results from classical topology of surfaces to transform the surface that has eliminated our crossings and make it compact by adding a point at infinity so that one gets a sphere with g′ handles. This manipulation, which is a classical technique, will put the surface in the form of a multi-holed doughnut surface with g′ holes. If now one cuts the surface so obtained as one would for a doughnut of the same shape to butter it (e.g., in the case of a one-holed doughnut or bagel, this would be the usual lateral cut that enables it to be buttered), one gets two surfaces with boundaries (made of g+1 connected components) each of the two surfaces carrying a part of the graph that has loose ends (the same number of loose ends on both pieces with an obvious pairing on the boundaries of the surfaces to get back the graph). The point is that the two pieces of graphs have no crossing, something which is very convenient to produce the graph aspects of the outputs of the present invention, and would similarly be useful for any aspect of graph representation. This would, in particular, enable the decomposition of any circuit or other graph into two pieces that have no crossing, these two pieces having loose ends that are easy to pair and then connect to get the desired circuit or other type of graph.

For the purpose of the invention (and some applications of graph layout design), the complete eradication of crossing as we have described is not the only way to go: one can also collapse some pieces that necessarily generate crossings if the genus of the surface where the graph lives in not increased, and then represent those pieces in separate figures where one could chose to increase genus or keep the crossings or a bit of both.

Some embodiments of the invention analyze the correlations of price data for stocks. For example, one embodiment uses the correlations to price options or derivative securities priced by baskets. One starts with the correlation matrix C for the securities on which the option (or other derivative security) depends. Notice that correlations may range between −1 and 1. One takes the matrix of absolute values of the correlations, then one gets a SSA/MDS configuration of points for some dimension value n chosen as small (or even as n=2) for ease or as small as possible to get zero strain. As described above, the one-parameter family of graphs is computed for this configuration of points. One then extracts for some value t of the parameter, where t is defined according to various performance criteria, a graph Gₜ whose incidence matrix G then gets element-wise multiplied with the original correlation matrix M to get a matrix M′=G**M, where for any two matrices A and B of the same size, A**B is defined so that the value at row i, column j of A**B equals A_{i,j}·B_{i,j}. The resulting matrix M′ is then used instead of the original correlation to have a simpler, more economical, computation of the price of the option than using any classical method, but with the simpler matrix M′ instead of the full correlation matrix M, since M′_{i,j}=0 for each pair (i,j) such that G_{i,j}=0, i.e., for each pair (i,j) such that there is no edge between the vertices that represent i and j.

Another embodiment of the invention may be used for network surveillance. In this embodiment, the entities are users of a network, and the relation is a measure of the traffic; for instance the average time between two communications, so that one naturally gets 0 for any pair of the form (i,j) as any element can be considered as permanently in contact with itself. The family of one-parameter graphs is computed, as described above. The family is recomputed at regular and or random times on every node and/or on suspect groups, and/or on random samples that are followed for some time. One can then recognize static abnormal configurations, such as nodes with too many strong links with respect to what is known of the entity represented by said node. By “strong links”, we mean links that remain there for small values of t. One also can use weighted graphs instead of graphs, where the weight is, for example, the relation measure (recall that a graph can be seen as a particular weighted graph, and more precisely a weighted graph with all weights set equal to the same non-zero value, such as 1); hence small value means strong link if one uses weighted graphs. It should be understood that correlations of activity, measured by the absolute value of the correlation of the volume of messages in and out, may be used as the relation. Dynamic anomalies such as abnormal surge in activity, can be seen from local differences on the graph as a function of time, or suspect spatiotemporal evolution that may reflect an order being relayed, loops in the circulation, etc. Any uncommon configuration can then be mentioned to human agents or specialized electronic agents for further investigation.

Another embodiment of the invention may be used for market surveillance, e.g., a national market or stock market, a derivatives market, or a commodities market: Similar to network surveillance, the relation is a correlation between prices of market items, and the one-parameter family of graphs is computed to identify strongly connected groups of items. Potential correlations are better known in the case of a market. There will also be a relation to events known to potentially affect the market being investigated.

One aspect of market surveillance consists in considering a market as a network with similarities given by the amount of commerce between two nodes that represent market players for instance. Then what has been said for network surveillance applies in particular to market surveillance.

In the case of both networks and markets; the advantage of the invention includes using a graph representation of the market or network activity so that distances can be easily computed. One can also restrict the graph to graphs of smaller sets of nodes (i.e., supernodes) in order to permit a more detailed observation, in particular as function of time, or extend the set of nodes to have a broader perspective and some context information. Another advantage is the possibility to tune the parameter value for better detection, control of price, and the tradeoff of these considerations. Both for networks and for markets, clustering the graphs may be used in order to detect the graphs out of cluster, or far from the major cluster, indicating that more attention should be paid to the nodes of such graphs.

Further embodiments of the invention use as relations the correlation between entities such as various indices such as the Dow Jones, The Nikkei Index, The S&P 500, Euro Stoxx, the CAC 40, various exchanges (on similar or different securities, such as the New York Stock Exchange, Nasdaq, CBT, etc.), and any entities significant for the market (for instance the price of oil, the activity of the exchanges, the NYSE volume, etc.), just to give a few examples. In particular, the time evolution of such graphs will provide visual hints for forecasting and understanding some global and local aspects of various markets.

We claim:

1. A computer-implemented method for visualization of relations among data items, comprising:
storing pair-wise relation values in a database, each of the pair-wise relation values representing a relation between two of the data items, such that the pair-wise relation values have a partial ordering;
translating the data items to a set of points in a geometric space, each point corresponding to a data item, such that the partial ordering of the pair-wise relation values is preserved by a distance metric on the geometric space;
computing a one-parameter family of graphs on the set of points, such that a graph is computed for a value of a parameter, the value of the parameter being chosen according to pre-defined performance criteria;
displaying at least one member of the one-parameter family of graphs to a user, where the at least one member is chosen according to the performance criteria.

2. The method of claim 1, where the one-parameter family of graphs is computed such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

3. The method of claim 1, where the pair-wise relation values express at least one of dissimilarity, similarity, or correlation between data items.

4. The method of claim 1, where the geometric space is Euclidean.

5. The method of claim 4, where the dimension of a Euclidean space is chosen according to a criterion chosen from the list including the ability to visualize the displayed graph and the closeness of the approximation to isotony in the translating of the data items.

6. The method of claim 1, where the step of translating the data items to a set of points in a geometric space further comprises performing one of multi-dimensional scaling or structural similarity analysis on the pair-wise relation values.

7. The method of claim 1, the step of computing the one-parameter graph family further comprising the steps of:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

8. The method of claim 1, further comprising, before the step of displaying, clustering the data points on at least one graph in the one-parameter family of graphs.

9. The method of claim 8, where the displayed graphs are the graphs on which clustering has been performed.

10. The method of claim 1, where the data items are nodes in an input graph, the pair-wise relation values being an inverse measure of connectedness between two data items, the pair-wise relation value for the two data items being determined in such a way that the pair-wise relation value for the two data items is directly related to a number of paths between the two data items and lengths of the paths between the two data items.

11. The method of claim 10, where the dimension of the geometric space is 2 and the displayed graph is further chosen such the displayed graph is planar, the displayed graph having an edge between two data items if the two data items are connected by an edge in the input graph.

12. The method of claim 10, where, if no member of the one-parameter graph family is planar, the displayed graph is made so that it can be represented on a surface by replacing each crossing with a handle.

13. The method of claim 10, where the input graph represents components of a circuit.

14. The method of claim 1, further comprising providing input pair-wise relation values that are correlations of data items, setting the pair-wise relation value for two data items to the absolute value of the input pair-wise relation value for the two data items, and computing output pair-wise relation values such that for two data items, the output pair-wise relation value of the two data items equals the pair-wise relation value of the two data items if the two data items are connected by an edge in the displayed graph and equals 0 otherwise.

15. The method of claim 14, where the data items represent at least one of prices of securities, prices of commodities, macroeconomic data, or other data used in financial markets.

16. The method of claim 15, where the output pair-wise relation values are used to visualize the overall correlation structure of the data items.

17. The method of claim 15, where the output pair-wise relation values are used to compute prices of derivative securities, the price of the derivative securities depending on the prices of the data items.

18. The method of claim 1, where the pair-wise relation values are pair-wise measures of traffic between two data items, the data items representing one of nodes in a network or entities in a market.

19. A computer-implemented method for recommending items to customers comprising:
storing pair-wise relation values for each customer in a first database, each of the pair-wise relation values representing a relation between two of the data items determined by the customer, such that the pair-wise relation values have a partial ordering;
performing for each customer the steps of:
translating the set of pair-wise relation values into a set of points in a geometric space, each point corresponding to an item, such that the partial ordering of the pair-wise relation values is preserved by a distance metric on the geometric space;
computing a one-parameter family of graphs on the set of points, such that a graph is computed for a value of a parameter, the value of the parameter being chosen according to pre-defined performance criteria;
clustering customers, where distance between two customers is the distance between the two customers identified graphs; and
providing a recommendation means for recommending items to customers based on the computed clusters of customers.

20. The method of claim 19, the recommendation means comprising, upon a customer request for recommended items, performing the steps of:
creating a list of items, where the items are preferred by the other customers in the customer's cluster, such that the customer has no known preference for the items; and
sending the list of items to the customer.

21. The method of claim 19, the recommendation means comprising, upon a customer request for recommended items, displaying clusters to which the customer belongs in such a way as to allow browsing of items preferred by customers in the displayed clusters.

22. The method of claim 19, where the one-parameter family of graphs is computed such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

23. The method of claim 19, where the pair-wise relation values express at least one of dissimilarity, similarity, or correlation between items.

24. The method of claim 19, where the geometric space is Euclidean.

25. The method of claim 24, where the dimension of a Euclidean space is chosen according to a criterion chosen from the list including the ability to visualize the displayed graph and the closeness of the approximation to isotony in the translating of the data items.

26. The method of claim 19, where the step of translating the data items to a set of points in a geometric space further comprises performing one of multi-dimensional scaling or structural similarity analysis on the pair-wise relation values.

27. The method of claim 19, where the items include a first element and a second element, such that a pair-wise relation value between an item and the first element indicates a customer's preference for the item and a pair-wise relation value between an item and the second element indicates a customer's distaste for the item.

28. The method of claim 19, the step of computing the one-parameter graph family further comprising the steps of:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

29. The method of claim 19, where a customer's relation values are updated as information is gathered about the customer's opinions about items.

30. The method of claim 29, where the steps of translating the set of pair-wise relation values into a set of points in a geometric space, computing a one-parameter family of graphs, choosing a parameter value based on performance criteria, identifying a member of the one-parameter graph family determined by the parameter value, and clustering customers are performed for the customer each time the customer's relation values are updated.

31. The method of claim 19, where the items are one of: pieces of music, collections of music, music genres, musical artists, particular recordings of pieces of music, videos, movies, books, groceries, or webpages.

32. A system for visualization of relations among data items, comprising:
a database for storing pair-wise relation values, each of the pair-wise relation values representing a relation between two of the data items, such that the pair-wise relation values have a partial ordering;
a translation module for translating the data items to a set of points in a geometric space, each point corresponding to a data item, such that the partial ordering of the pair-wise relation values is preserved by a distance metric on the geometric space;
a graph family module for computing a one-parameter family of graphs on the set of points, such that a graph is computed for a value of a parameter, the value of the parameter being chosen according to pre-defined performance criteria;
a display module for displaying at least one member of the one-parameter family of graphs to a user, where the at least one member is chosen according to the performance criteria.

33. The system of claim 32, where the graph family module computes the one-parameter family of graphs such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

34. The system of claim 32, where the pair-wise relation values express at least one of dissimilarity, similarity, or correlation between data items.

35. The system of claim 32, where the geometric space is Euclidean.

36. The system of claim 35, where the translation module chooses the dimension of a Euclidean space according to a criterion chosen from the list including the ability to visualize the displayed graph and the closeness of the approximation to isotony in the translating of the data items.

37. The system of claim 32, where the translation module performs the translating the data items to a set of points in a geometric space by performing one of multi-dimensional scaling or structural similarity analysis on the pair-wise relation values.

38. The system of claim 32, wherein the graph family module computes the one-parameter graph family by:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

39. The system of claim 32, further including a clustering module for clustering the data points on at least one graph in the one-parameter family of graphs.

40. The system of claim 39, where the displayed graphs are the graphs on which clustering has been performed.

41. The system of claim 32, where the data items are nodes in an input graph, the pair-wise relation values being an inverse measure of connectedness between two data items, the pair-wise relation value for the two data items being determined in such a way that the pair-wise relation value for the two data items is directly related to a number of paths between the two data items and lengths of the paths between the two data items.

42. The system of claim 41, where the dimension of the geometric space is 2 and the displayed graph is further chosen such the displayed graph is planar, the displayed graph having an edge between two data items if the two data items are connected by an edge in the input graph.

43. The system of claim 41, where, if no member of the one-parameter graph family is planar, the display module makes the displayed graph so that it can be represented on a surface by replacing each crossing with a handle.

44. The system of claim 41, where the input graph represents components of a circuit.

45. The system of claim 32, further comprising providing input pair-wise relation values that are correlations of data items, setting the pair-wise relation value for two data items to the absolute value of the input pair-wise relation value for the two data items, and computing output pair-wise relation values such that for two data items, the output pair-wise relation value of the two data items equals the pair-wise relation value of the two data items if the two data items are connected by an edge in the displayed graph and equals 0 otherwise.

46. The system of claim 45, where the data items represent at least one of prices of securities, prices of commodities, macroeconomic data, or other data used in financial markets.

47. The system of claim 46, where the output pair-wise relation values are used to visualize the overall correlation structure of the data items.

48. The system of claim 46, where the output pair-wise relation values are used to compute prices of derivative securities, the price of the derivative securities depending on the prices of the data items.

49. The system of claim 32, where the pair-wise relation values are pair-wise measures of traffic between two data items, the data items representing one of nodes in a network or entities in a market.

50. A system for recommending items to customers comprising:
a database storing pair-wise relation values for each customer, each of the pair-wise relation values representing a relation between two of the data items determined by the customer, such that the pair-wise relation values have a partial ordering;
a clustering module for clustering customers by performing for each customer:
translating the set of pair-wise relation values into a set of points in a geometric space, each point corresponding to an item, such that the partial ordering of the pair-wise relation values is preserved by a distance metric on the geometric space;
computing a one-parameter family of graphs on the set of points, such that a graph is computed for a value of a parameter, the value of the parameter being chosen according to pre-defined performance criteria;
clustering customers, where distance between two customers is the distance between the two customers identified graphs; and
a recommendation module for recommending items to customers based on the computed clusters of customers.

51. The system of claim 50, the recommendation module, upon receiving a customer request for recommended items, recommending items by:
creating a list of items, where the items are preferred by the other customers in the customer's cluster, such that the customer has no known preference for the items; and
sending the list of items to the customer.

52. The system of claim 50, the recommendation module, upon a customer request for recommended items, displaying clusters to which the customer belongs in such a way as to allow browsing of items preferred by customers in the displayed clusters.

53. The system of claim 50, where the one-parameter family of graphs is computed such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

54. The system of claim 50, where the pair-wise relation values express at least one of dissimilarity, similarity, or correlation between items.

55. The system of claim 50, where the geometric space is Euclidean.

56. The system of claim 55, where the clustering module chooses the dimension of a Euclidean space according to a criterion chosen from the list including the ability to visualize the displayed graph and the closeness of the approximation to isotony in the translating of the data items.

57. The system of claim 50, where the clustering module performs the step of translating the data items to a set of points in a geometric space by performing one of multi-dimensional scaling or structural similarity analysis on the pair-wise relation values.

58. The system of claim 50, where the items include a first element and a second element, such that a pair-wise relation value between an item and the first element indicates a customer's preference for the item and a pair-wise relation value between an item and the second element indicates a customer's distaste for the item.

59. The system of claim 50, the step of computing the one-parameter graph family further comprising the steps of:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

60. The system of claim 50, where a customer's relation values are updated as information is gathered about the customer's opinions about items.

61. The system of claim 60, where the clustering module, performs translating the set of pair-wise relation values into a set of points in a geometric space, computing a one-parameter family of graphs, choosing a parameter value based on performance criteria, identifying a member of the one-parameter graph family determined by the parameter value, and clustering customers for the customer each time the customer's relation values are updated.

62. The system of claim 50, where the items are one of: pieces of music, collections of music, music genres, musical artists, particular recordings of pieces of music, videos, movies, books, groceries, or webpages.

63. A computer-readable medium encoding instructions for performing a method for visualization of relations among data items, comprising:
storing pair-wise relation values in a database, each of the pair-wise relation values representing a relation between two of the data items, such that the pair-wise relation values have a partial ordering;
translating the data items to a set of points in a geometric space, each point corresponding to a data item, such that the partial ordering of the pair-wise relation values is preserved by a distance metric on the geometric space;
computing a one-parameter family of graphs on the set of points, such that a graph is computed for a value of a parameter, the value of the parameter being chosen according to pre-defined performance criteria;
displaying at least one member of the one-parameter family of graphs to a user, where the at least one member is chosen according to the performance criteria.

64. The computer-readable medium of claim 63, where the one-parameter family of graphs is computed such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

65. The computer-readable medium of claim 63, where the pair-wise relation values express at least one of dissimilarity, similarity, or correlation between data items.

66. The computer-readable medium of claim 63, where the geometric space is Euclidean.

67. The computer-readable medium of claim 66, where the dimension of a Euclidean space is chosen according to a criterion chosen from the list including the ability to visualize the displayed graph and the closeness of the approximation to isotony in the translating of the data items.

68. The computer-readable medium of claim 63, where the step of translating the data items to a set of points in a geometric space further comprises performing one of multi-dimensional scaling or structural similarity analysis on the pair-wise relation values.

69. The computer-readable medium of claim 63, the step of computing the one-parameter graph family further comprising the steps of:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

70. The computer-readable medium of claim 63, further comprising, before the step of displaying, clustering the data points on at least one graph in the one-parameter family of graphs.

71. The computer-readable medium of claim 70, where the displayed graphs are the graphs on which clustering has been performed.

72. The computer-readable medium of claim 63, where the data items are nodes in an input graph, the pair-wise relation values being an inverse measure of connectedness between two data items, the pair-wise relation value for the two data items being determined in such a way that the pair-wise relation value for the two data items is directly related to a number of paths between the two data items and lengths of the paths between the two data items.

73. The computer-readable medium of claim 72, where the dimension of the geometric space is 2 and the displayed graph is further chosen such the displayed graph is planar, the displayed graph having an edge between two data items if the two data items are connected by an edge in the input graph.

74. The computer-readable medium of claim 72, where, if no member of the one-parameter graph family is planar, the displayed graph is made so that it can be represented on a surface by replacing each crossing with a handle.

75. The computer-readable medium of claim 72, where the input graph represents components of a circuit.

76. The computer-readable medium of claim 63, further comprising providing input pair-wise relation values that are correlations of data items, setting the pair-wise relation value for two data items to the absolute value of the input pair-wise relation value for the two data items, and computing output pair-wise relation values such that for two data items, the output pair-wise relation value of the two data items equals the pair-wise relation value of the two data items if the two data items are connected by an edge in the displayed graph and equals 0 otherwise.

77. The computer-readable medium of claim 76, where the data items represent at least one of prices of securities, prices of commodities, macroeconomic data, or other data used in financial markets.

78. The computer-readable medium of claim 77, where the output pair-wise relation values are used to visualize the overall correlation structure of the data items.

79. The computer-readable medium of claim 77, where the output pair-wise relation values are used to compute prices of derivative securities, the price of the derivative securities depending on the prices of the data items.

80. The computer-readable medium of claim 63, where the pair-wise relation values are pair-wise measures of traffic between two data items, the data items representing one of nodes in a network or entities in a market.

81. A computer-readable medium encoding instructions for performing a method for recommending items to customers comprising:
storing pair-wise relation values for each customer in a first database, each of the pair-wise relation values representing a relation between two of the data items determined by the customer, such that the pair-wise relation values have a partial ordering;
performing for each customer the steps of:
translating the set of pair-wise relation values into a set of points in a geometric space, each point corresponding to an item, such that the partial ordering of the pair-wise relation values is preserved by a distance metric on the geometric space;
computing a one-parameter family of graphs on the set of points, such that a graph is computed for a value of a parameter, the value of the parameter being chosen according to pre-defined performance criteria;
clustering customers, where distance between two customers is the distance between the two customers identified graphs; and
providing a recommendation means for recommending items to customers based on the computed clusters of customers.

82. The computer-readable medium of claim 81, the recommendation means comprising, upon a customer request for recommended items, performing the steps of:
creating a list of items, where the items are preferred by the other customers in the customer's cluster, such that the customer has no known preference for the items; and
sending the list of items to the customer.

83. The computer-readable medium of claim 81, the recommendation means comprising, upon a customer request for recommended items, displaying clusters to which the customer belongs in such a way as to allow browsing of items preferred by customers in the displayed clusters.

84. The computer-readable medium of claim 81, where the one-parameter family of graphs is computed such that for two values of the parameter the graph computed for the higher of the two values of the parameter contains the graph computed for the lower of the two values of the parameter, for a first value of the parameter the graph computed for the first value of the parameter is a Gabriel graph for the set of points, for a second value of the parameter the graph computed for the second value of the parameter is a Delone graph for the set of points, the first value of the parameter being less than the second value of the parameter.

85. The computer-readable medium of claim 81, where the pair-wise relation values express at least one of dissimilarity, similarity, or correlation between items.

86. The computer-readable medium of claim 81, where the geometric space is Euclidean.

87. The computer-readable medium of claim 86, where the dimension of a Euclidean space is chosen according to a criterion chosen from the list including the ability to visualize the displayed graph and the closeness of the approximation to isotony in the translating of the data items.

88. The computer-readable medium of claim 81, where the step of translating the data items to a set of points in a geometric space further comprises performing one of multi-dimensional scaling or structural similarity analysis on the pair-wise relation values.

89. The computer-readable medium of claim 81, where the items include a first element and a second element, such that a pair-wise relation value between an item and the first element indicates a customer's preference for the item and a pair-wise relation value between an item and the second element indicates a customer's distaste for the item.

90. The computer-readable medium of claim 81, the step of computing the one-parameter graph family further comprising the steps of:
computing Delone spheres, the Delone sphere being a sphere of dimension one less than the dimension of the geometric space that is circumscribed to points in a defining subset of points from the set of points, a size of the defining subset of points being one plus the dimension of the geometric space, the Delone sphere being computed such that no point from the set of points other than the defining subset of points is contained in a closure of a ball bounded by the Delone sphere;
computing a Delone graph by identifying, for each Delone sphere, each edge such that endpoints of the edge are contained in the defining subset of points for the Delone sphere;
computing a Gabriel graph by identifying each edge of the Delone graph, endpoints of the edge being a first point from the set of points and a second point from the set of points, the first and second points defining a zero-dimensional sphere such that no other points from the set of points are on a closure of an interior of a ball of dimension equal to the dimension of the geometric space, the ball having the same center and same radius as the zero-dimensional sphere;
selecting intermediate subsets of points, where, for each Delone sphere, the intermediate subset of points is a subset of the defining subset of points for the Delone sphere such that a size of the intermediate subset of points is a whole number h+1 where h is greater than 1 and less than the dimension of the geometric space, the intermediate subset of points being selected if a closed ball of the same dimension as the geometric space, the closed ball having the same center and the same radius as a sphere with dimension h−1 circumscribed to the points in the proper subset of the defining subset of points, contains no point from the set of points other than the points in the intermediate subset of points;
for each edge in the Delone graph, computing the minimal circumscribed sphere for the edge, where the minimal circumscribed sphere is computed by:
choosing a selected intermediate subset such that the selected intermediate subset is contained in the defining subset of points containing the endpoints of the edge, where there is no such selected intermediate subset having smaller size, setting the minimal circumscribed sphere equal to the sphere with dimension h−1 circumscribed to the points in the selected intermediate subset;
if no such selected intermediate subset exists, setting the minimal circumscribed sphere equal to the Delone sphere for the defining subset of points containing the endpoints of the edge;
for each edge in the Delone graph, computing a distance between a midpoint of the edge and the center of the minimal circumscribed sphere for the edge;
for each edge in the Delone graph, computing a computed ratio of the distance and a length of the edge;
determining the maximal computed ratio over all edges in the Delone graph; and
for a parameter value, computing a graph for the parameter value by adding to the computed graph each edge from the Delone graph such that a ratio of the computed ratio for the edge and the maximal computed ratio is less than or equal to the parameter value.

91. The computer-readable medium of claim 81, where a customer's relation values are updated as information is gathered about the customer's opinions about items.

92. The computer-readable medium of claim 91, where the steps of translating the set of pair-wise relation values into a set of points in a geometric space, computing a one-parameter family of graphs, choosing a parameter value based on performance criteria, identifying a member of the one-parameter graph family determined by the parameter value, and clustering customers are performed for the customer each time the customer's relation values are updated.

93. The computer-readable medium of claim 81, where the items are one of: pieces of music, collections of music, music genres, musical artists, particular recordings of pieces of music, videos, movies, books, groceries, or webpages.
